(19) United States
(12) Patent Application Publication
(10) Pub. No.: US 2016/0062930 A1
(43) Pub. Date: Mar. 3, 2016

(54) BUS MASTER, BUS SYSTEM, AND BUS CONTROL METHOD

(71) Applicant: MITSUBISHI ELECTRIC CORPORATION, Chiyoda-ku, Tokyo (JP)

(72) Inventors: Junko KIJIMA, Tokyo (JP); Masahiro NAITO, Tokyo (JP)

(73) Assignee: MITSUBISHI ELECTRIC CORPORATION, Tokyo (JP)

(21) Appl. No.: 14/768,021

(22) PCT Filed: Jan. 29, 2014
(86) PCT No.: PCT/JP2014/051959

§ 371 Date: Aug. 14, 2015

(30) Foreign Application Priority Data
Mar. 25, 2013 (JP) 2013-061994

(51) Int. Cl. G06F 13/364; G06F 13/40; G06F 13/42

(52) U.S. Cl. CPC G06F 13/364; G06F 13/4282; G06F 13/404

(57) ABSTRACT

There is provided: an access generation unit (111) that generates a command information item including a transfer type indicating a type of transfer request requesting a data transfer and a transfer target address of a bus slave to which the transfer request is directed; a command queue (112) that stores a plurality of command information items generated by the access generation unit (111); a transfer request output sequence control unit (114) that selects second command information item before first command information item as output target command information item from the plurality of command information items stored in the command queue (112), the second command information item including a transfer target address possessed by a second bus slave that responds more slowly than a first bus slave possessing the transfer target address included in the first command information item; and a transfer request output unit (115) that outputs the command information item selected by the transfer request output sequence control unit (114).

### TECHNICAL FIELD

The present invention relates to a bus master, a bus system, and a bus control method.

### BACKGROUND ART

With advances in fine processes in recent years, system LSIs, in which a CPU (Central Processing unit), a graphics controller, and at least several hundred kilobytes of cache memory are incorporated into a single LSI, are being mounted in communication devices, image processing devices, or the like. In such system LSIs, the modules are interconnected by a system bus, through which data are transferred.

Structures complying with the AXI protocol developed by ARM Ltd. in the United Kingdom have become the mainstream on-chip bus standard for system LSIs. In an on-chip bus structure complying with the AXI protocol, bus masters such as the CPU, graphics controller, DMA (Direct Memory Access) controller, and the like, and bus slaves such as the cache memory, external memory typified by DRAM (Dynamic Random Access Memory), and the like, are interconnected point-to-point through a bus interconnect. In order to complete a write operation or read operation directed toward a bus slave, a bus master must wait until a write response channel signal or a read data channel signal is output from the bus slave. Therefore, to improve the data transfer performance of the bus system, it is necessary to shorten the bus master's waiting time.

A bus system having a bus master that performs the next access after receiving a write response signal indicating the result of writing data in a write access is described in patent reference 1. Here this bus system has a signal generation part that outputs a dummy write response channel signal to the bus master when it detects the end of a write data signal output from the bus master.

Since the bus master in the bus system described in patent reference 1 receives the dummy write response channel signal before it receives an authentic write response channel signal, it can start preparations for the next access in response to the dummy write response channel signal. The write process in the bus slave and the process of preparing for the next access in the bus master can therefore be carried out in parallel. Accordingly, in bus masters that are restricted to issuing one write command at a time, the delay time when one write access is followed immediately by another write access or by a read access can be shortened. That is, when write access is carried out, the data transfer performance can be improved.

### PRIOR ART REFERENCE

### Patent Reference

Patent reference 1: Japanese patent application publication No. 2011-95978 (paragraphs 0032-0052, FIG. 2)

### SUMMARY OF THE INVENTION

### Problems to be Solved by the Invention

In the conventional art, however, it is not possible to output data transfer requests successively, because during the interval from issuance of the dummy write response channel signal to reception of the authentic write response channel signal, the next write address channel signals and read address channel signals are masked. Therefore it is not possible to obtain the effect of improving data transfer performance by performing a plurality of data transfers in parallel such as the out-of-order transfers specified by AXI.

The present invention is made to solve the problem described above and an object of the present invention is to improve data transfer performance by controlling the order in which transfer request command information items are sent.

### Means for Solving the Problem

In one aspect of the invention, a bus master comprising: an access generation unit that generates a command information item including a transfer type indicating a type of transfer request that requests a transfer of data and a transfer target address of a bus slave to which the transfer request is directed; a command queue that stores a plurality of the command information items generated by the access generation unit; a transfer request output sequence control unit that selects a second command information item before a first command information item as a output target command information item from the plurality of command information items stored in the command queue, the second command information item including a transfer target address possessed by a second bus slave that responds more slowly than a first bus slave possessing the transfer target address included in the first command information item; and a transfer request output unit that outputs the command information item selected by the transfer request output sequence control unit to the bus slave possessing the transfer target address included in the selected command information item.

In another aspect of the invention, a bus system having at least one bus master and a plurality of bus slaves, wherein the at least one bus master comprises: an access generation unit that generates a command information item including a transfer type indicating a type of transfer request that requests a transfer of data and a transfer target address of one bus slave, to which the transfer request is directed, among the plurality of bus slaves; a command queue that stores a plurality of the command information item generated by the access generation unit; a transfer request output sequence control unit that selects second command information item before first command information item as output target command information item from the plurality of command information items stored in the command queue, the second command information item including a transfer target address possessed by a second bus slave that responds more slowly than a first bus slave possessing the transfer target address included in the first command information item; and a transfer request output unit that outputs the command information item selected by the transfer request output sequence control unit to the bus slave possessing the transfer target address included in the selected command information item.

In another aspect of the invention, a bus control method comprising: an access generation step that generates a command information item including a transfer type indicating a type of transfer request that requests a transfer of data and a transfer target address of a bus slave to which the transfer request is directed; a command queuing step that stores a plurality of the command information items generated in the access generation step; a transfer request output sequence control step that selects second command information item before first command information item as output target command information item from the plurality of command information items stored in the command queuing step, the second command information item including a transfer target address possessed by a second bus slave that responds more slowly than a first bus slave possessing the transfer target address included in the first command information item; and a transfer request output step that outputs the command information item selected in the transfer request output sequence control step to the bus slave possessing the transfer target address included in the selected command information item.

### Effect of the Invention

According to one aspect of the present invention, data transfer performance can be improved by controlling the order in which transfer request command information items are sent.

### BRIEF DESCRIPTION OF THE DRAWINGS

FIG. 1 is a block diagram schematically illustrating the configuration of bus systems according to the first to third embodiments.

FIG. 2 is a block diagram schematically illustrating the configuration of a bus master 110 in the first embodiment.

FIG. 3 is a schematic diagram illustrating information stored in a command queue in the first embodiment.

FIG. 4 is a schematic diagram illustrating an example of address map information in the first embodiment.

FIG. 5 is a schematic diagram illustrating an example of transfer sequence coherency information in the first embodiment.

FIG. 6 is a flowchart illustrating a process of updating the transfer sequence coherency information by a command queue retention time comparison unit in the first embodiment.

FIG. 7 is a flowchart illustrating a process when a transfer request output sequence control unit in the first embodiment selects a command information item of any queue item number stored in a command queue by referring to the transfer sequence coherency information.

FIG. 8 is a timing diagram illustrating operation before the transfer sequence coherency information is updated in the first embodiment.

FIG. 9 is a timing diagram illustrating operation after the transfer sequence coherency information is updated in the first embodiment.

FIG. 10 is a block diagram schematically illustrating the configuration of a bus master in the second embodiment.

FIG. 11 is a schematic diagram illustrating an example of transfer response input time information stored in a transfer response input time storage unit in the second embodiment.

FIG. 12 is a block diagram schematically illustrating the configuration of a bus master in the third embodiment.

FIG. 13 is a timing diagram illustrating the operation of a bus master in the third embodiment.

FIG. 14 is a block diagram schematically illustrating the configuration of a bus system according to a fourth embodiment.

FIG. 15 is a block diagram schematically illustrating the configuration of a bus master in the fourth embodiment.

FIG. 16 is a flowchart (part 1) illustrating a process when a queue control unit obtains a transfer response input time signals from the bus masters and supplies output number control signals to the bus masters in the fourth embodiment.

FIG. 17 is a flowchart (part 2) illustrating the process when a queue control unit obtains transfer response input time signals from the bus masters and supplies output number control signals to the bus masters in the fourth embodiment.

FIG. 18 is a timing diagram illustrating operation of the bus master when a transfer request output sequence control unit in the fourth embodiment places an upper limit restriction on the number of transfer requests output to a bus slave.

FIG. 19 is a block diagram schematically illustrating the configuration of a bus system according to a fifth embodiment.

FIG. 20 is a block diagram schematically illustrating the configuration of a bus master in the fifth embodiment.

FIG. 21 is a flowchart (part 1) illustrating a process when a transfer request output sequence control unit in the fifth embodiment selects a command information item with any one of queue item numbers stored in a command queue, by referring to transfer sequence coherency information and the maximum transfer request number of a bus slave.

FIG. 22 is a flowchart (part 2) illustrating the process when the transfer request output sequence control unit in the fifth embodiment selects a command information item of any one of queue item numbers stored in a command queue, by referring to transfer sequence coherency information and the maximum transfer request number of a bus slave.

### MODE FOR CARRYING OUT THE INVENTION

### First Embodiment

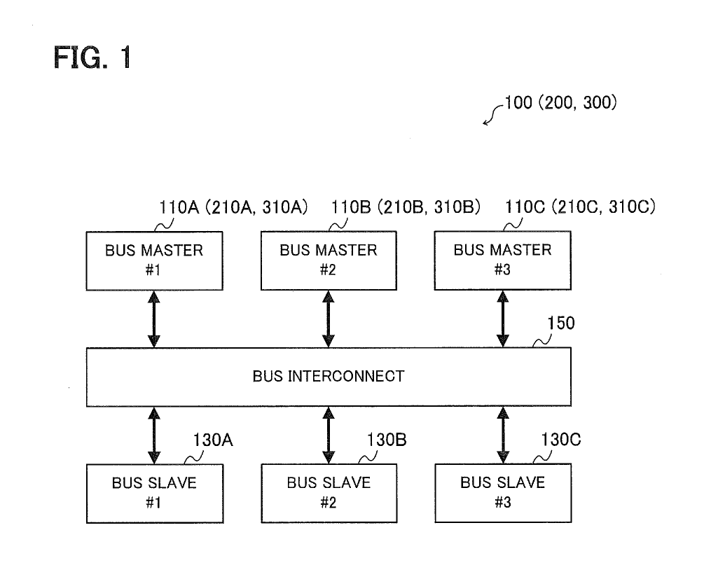

FIG. 1 is a block diagram schematically illustrating a configuration of a bus system 100 according to a first embodiment. In the bus system 100, bus masters 110A to 110C (referred to as bus masters 110 when it is not particularly necessary to distinguish among them) and bus slaves 130A to 130C (referred to as bus slaves 130 when it is not particularly necessary to distinguish among them) are interconnected through a bus interconnect 150. The bus system 100 is an on-chip bus complying with the AXI protocol. Reference numbers in parentheses in FIG. 1 apply to configurations in the second and third embodiments.

As to the bus masters 110 shown in FIG. 1, numbers written after sharp signs (#) are bus master numbers as bus master identification information for identifying the bus masters 110. As to the bus slaves 130 shown in FIG. 1, numbers written after sharp signs (#) are bus slave numbers as bus slave identification information for identifying the bus slaves 130.

The bus master 110 is a CPU, graphics controller, DMA controller, or the like. The bus slave 130 is a cache memory, DRAM, or the like.

First, the AXI protocol will be described with reference to FIG. 1.

In the AXI protocol, transfer between the bus master 110 and the bus slave 130 can be performed independently on each path. For example, in FIG. 1, a data transfer between the bus master 110A and bus slave 130A and a data transfer between the bus master 110B and bus slave 130B can be performed independently.

The AXI protocol defines five channels: a write address channel, write data channel, write response channel, read address channel, and read data channel. These channels can operate independently even on the same path. These channels can be operated independently from each other even on the same path. For example, write address channel signals may be successively issued multiple times, or transmission and reception of a write channel signal and transmission and reception of a read channel signal may be simultaneously performed. That is, in the AXI protocol, multiple data transfers can be performed in parallel.

Moreover, a different transfer ID is given, for each transfer, to each channel. For example, when the bus master 110A outputs read address channel signals to two or more of the bus slaves 130A to 130C by using different transfer IDs, two or more data transfers are executed in parallel by the bus slaves 130A to 130C.

The time required for the bus slaves 130A to 130C to process a transfer request input from the bus master 110A depends on respective operating frequencies of the bus slaves 130A to 130C and read cycle counts of the memories or the like that constitute the bus slaves 130A to 130C. Accordingly, the sequence in which the transfer responses are output from the bus slaves 130A-130C through the bus interconnect 150 to the bus master 110A does not necessarily match the sequence in which the transfer requests were received from bus master 110A. The AXI protocol supports these out-of-order transfers and can execute a plurality of data transfers efficiently in parallel.

In each of the channels, handshaking is performed between the bus master 110 and bus slave 130, by using a Valid signal and a Ready signal. The bus master 110 outputs Valid signals on the write address channel, write data channel, and read address channel, and the bus slave 130 outputs corresponding Ready signals for each of them. The bus slave 130 outputs Valid signals on the write response channel and read data channel, and the bus master 110 outputs corresponding Ready signals for responding to each of them. Incidentally, the Valid signals and Ready signals are given different names on different channels so that they can be discriminated.

For example, in data writing from the bus master 110A to the bus slave 130A, the bus master 110A outputs a write address channel signal and a write data channel signal with respective Valid signals. The bus slave 130A obtains the write address channel signal and write data channel signal input from the bus master 110A by outputting Ready signals, and starts a write process.

The time required by the bus slave 130 to perform a write process varies with the individual bus slaves 130, depending on the operating frequencies at which the bus slaves 130 are driven, their data writing procedures, and so on. If the bus slave 130A is a fast access cache memory configured by a SRAM (Static Random Access Memory), for example, its operating frequency is equal to or greater than that of the bus interconnect 150, and the bus slave 130A completes the write process in one clock cycle at the fastest.

If the bus slave 130A is an external serial interface or the like, since the processing speed of the interface is relatively low speed and a bus signal need be divided into several parts, many cycles are needed until the write process is completed.

Completing the writing process, the bus slave 130A outputs a write response channel signal with a Valid signal to the bus master 110A. The bus master 110A obtains the write response channel signal by outputting a Ready signal, and completes a series of write operation.

In data reading from the bus master 110A to the bus slave 130A, the bus master 110A outputs a read address channel signal with a Valid signal. The bus slave 130A obtains the read address channel signal input from the bus master 110A by outputting a Ready signal, and starts a read process.

The time required by bus slave 130A to perform a read process varies with the individual bus slave 130A, as described earlier. Completing the reading process, the bus slave 130A outputs a read data channel signal with a Valid signal to the bus master 110A. The bus master 110A obtains the read data channel signal by outputting a Ready signal, and completes a series of read operation.

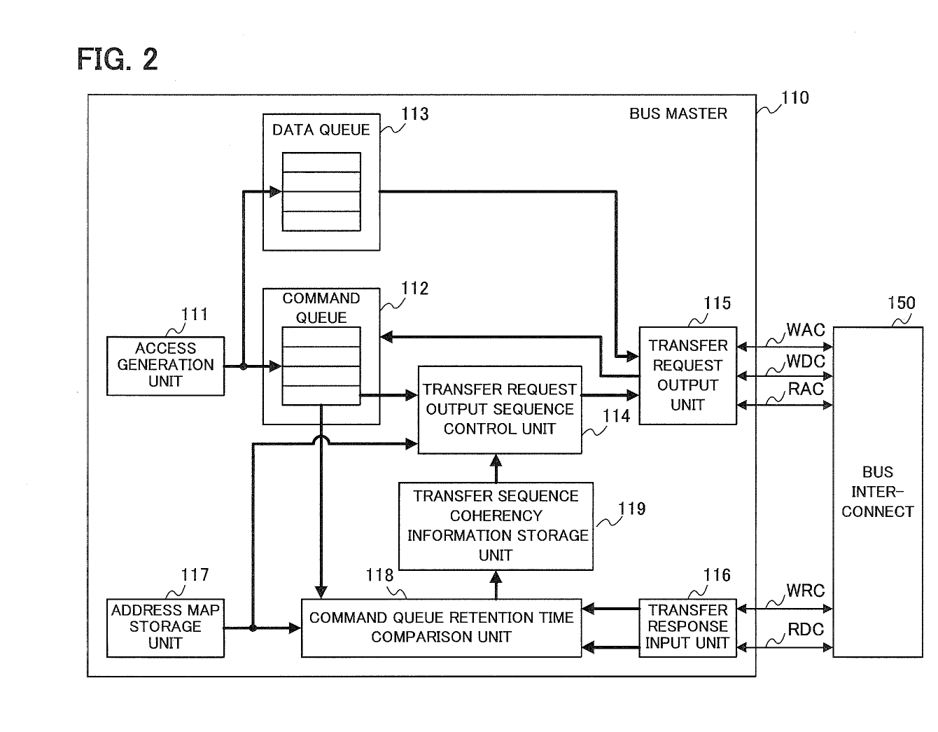

FIG. 2 is a block diagram schematically illustrating a configuration of the bus master 110 in the first embodiment. The bus master 110 includes an access generation unit 111, a command queue 112, a data queue 113, a transfer request output sequence control unit 114, a transfer request output unit 115, a transfer response input unit 116, an address map storage unit 117, a command queue retention time comparison unit 118, and a transfer sequence coherency information storage unit 119.

The bus master 110 is a module that transfers data to a memory or peripheral device, for example, such as a CPU or DMA controller. So, the access generation unit 111 generates a data transfer request and supplies the transfer request to the command queue 112 and the data queue 113. The transfer request includes a command information item that has the transfer type of reading or writing, a transfer target address, and a transfer data length (also called a burst length), and writing data in a case where the transfer type is writing. The access generation unit 111 stores, in the command queue 112, the command information item that includes the transfer type, transfer target address, and transfer data length, and stores the writing data in the data queue 113. In other words, the access generation unit 111 generates the command information item including a transfer type indicating the type of transfer request for requesting a data transfer and the transfer target address of a bus slave to which the transfer request is sent, and stores the command information item in the command queue 112.

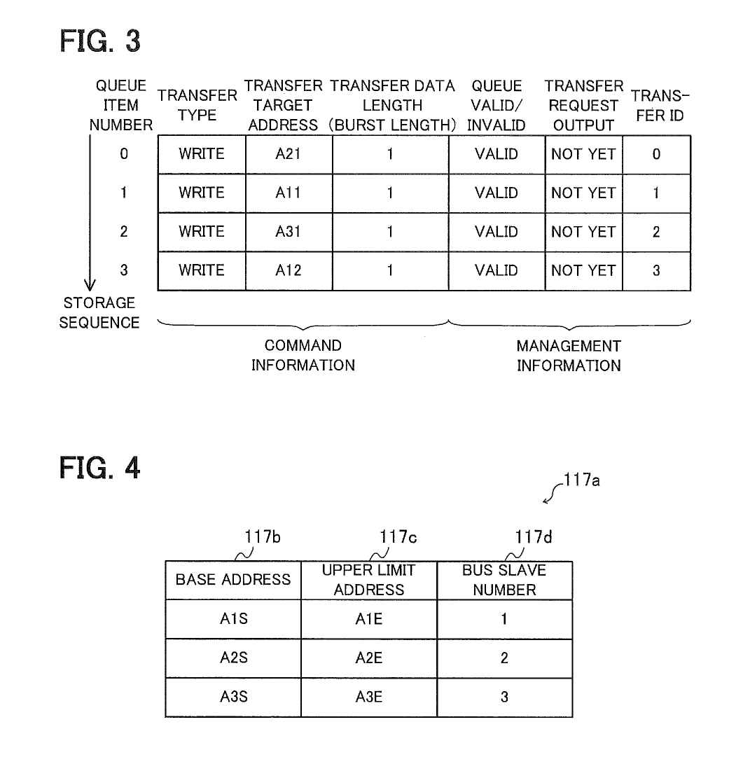

The command queue 112 stores the command information item generated by the access generation unit 111. In addition to the command information item, the command queue 112 also stores management information item for managing the command information item. FIG. 3 is a schematic diagram illustrating the information stored in the command queue 112. Although FIG. 3 illustrates an example where the number of queue items constituting the command queue 112 is ‘4’ and the information is stored in regions to which queue item numbers ‘0’ to ‘3’ are assigned, it may be constituted by an arbitrary number of queue items depending on the operating speed of the bus master 110, the quantity of transfer data or the like.

Each command information item includes the transfer type, transfer target address, and transfer data length given by the access generation unit 111.

The transfer type is information indicating the type of transfer request for requesting a data transfer. The transfer type here is ‘write’ to write data to a bus slave 130 or ‘read’ to read data from a bus slave 130.

The transfer target address is the address of the bus slave 130 to which the transfer request is sent.

The transfer data length is information indicating the size of the data to be transferred.

The management information item includes queue valid/invalid information, transfer request output information, and the transfer ID for each command information item.

The queue valid/invalid information indicates whether the corresponding command information item is valid or invalid. If the queue valid/invalid information indicates ‘invalid’, the corresponding command information item has been deleted.

The transfer request output information indicates whether the corresponding command information item has been output or not. If the transfer request output information is ‘not yet’, it indicates that the corresponding command information item has not been sent to the bus slave 130; if the transfer request output information is ‘already’, it indicates that the corresponding command information item has been sent.

The transfer ID is transfer identification information for identifying each command information item.

The command queue 112 stores each command information item and the related management information item in regions with queue item numbers ‘0’ to ‘3’, in an order of supply of the command information items from the access generation unit 111. In other words, the command information item first supplied to the command queue 112 and the related management information item are stored in the region with queue item number ‘0’; the command information item next supplied and the related management information item are stored in the region with queue item number ‘1’. The queue item numbers thus indicate an order of supply of the command information item from the access generation unit 111.

The transfer request output sequence control unit 114 selects second command information item, as an output target command information item, out of the plurality of command information items stored in the command queue 112, before first command information item; the second command information item includes a transfer target address possessed by a second bus slave that responds later than a first bus slave possessing the transfer target address included in the first command information item. The transfer request output sequence control unit 114 selects an output target command information item by referring to transfer sequence coherency information stored in the transfer sequence coherency information storage unit 119, thereby controlling an order of output of the command information items stored in the command queue 112, for example. More specifically, the transfer request output sequence control unit 114 determines whether to output the command information items stored in the command queue 112 to the bus interconnect 150 in an order of storing, or to output to the bus interconnect 150 a command information item stored later before a command information item stored earlier. Then, the transfer request output sequence control unit 114 selects a command information item to be output in accordance with a result of the determination. The selected command information item is output from the transfer request output unit 115 to the bus interconnect 150. If the transfer type of the command information item is ‘write’, the write data stored in the data queue 113 is output as well.

The transfer request output unit 115 outputs the command information item selected by the transfer request output sequence control unit 114 to the bus slave 130 having the transfer target address included in the selected command information item. The specific processing at the transfer request output unit 115 will be described below.

When the transfer request output unit 115 outputs a command information item stored in the command queue 112 to the bus interconnect 150, it assigns a transfer ID. The transfer IDs are distinguished independently in the bus interconnect 150 in each read or write operation. The assigned transfer ID may simply be the queue item number at which the command information item is stored in the command queue 112, or it may be, in each read or write operation, the smallest number (an integer equal to or greater than 0) excluding the transfer IDs of the command information item that has already been output. When a transfer ID is assigned, the transfer request output unit 115 stores the assigned transfer ID in the command queue 112 as management information item for the address information to which the transfer ID is assigned.

If the type of a command information item stored in the command queue 112 is ‘write’, the transfer request output unit 115 outputs a write address channel signal WAC indicating the command information item stored in the command queue 112 and a write data channel signal WDC indicating the write data stored in the data queue 113, together with Valid signals, to the bus interconnect 150.

If the type of a command information item stored in the command queue 112 is ‘read’, the transfer request output unit 115 sends a read address channel signal RAC indicating the command information item stored in the command queue 112, together with a Valid signal, to the bus interconnect 150.

The bus slaves 130 are connected to the bus interconnect 150 as shown in FIG. 1.

The bus interconnect 150 transfers the write address channel signals WAC, write data channel signals WDC, and read address channel signals RAC to the bus slaves 130 corresponding to the transfer target addresses. The bus slaves 130 receive these signals by outputting Ready signals indicating that the signals are receivable. If the transfer data length is greater than ‘1’, as many write data channel signals WDC as the data length are output. When outputting the last write data channel signal WDC, the transfer request output unit 115 outputs a Last signal with a Valid signal.

When receiving the write address channel signal WAC and the write data channel signal WDC, the bus slave 130 then outputs a write response channel signal WRC to the bus interconnect 150, together with a Valid signal. Here, if the transfer data length is greater than ‘1’, the bus slave 130 outputs the write response channel signal WRC when the reception of the last write data channel signal WDC is completed.

When receiving a read address channel signal RAC, the bus slave 130 then outputs a read data channel signal RDC indicating corresponding read data to the bus interconnect 150, together with a Valid signal. Here, if the transfer data length is greater than ‘1’, the bus slave 130 outputs a Last signal together with a Valid signal when outputting the last read data channel signal RDC.

Whether a bus slave 130 can accept a transfer request immediately or not is decided for each of the bus slaves 130 depending on the operating frequency and transfer data processing method. If the bus slave 130 cannot accept the transfer request immediately, the bus slave 130 delays the Ready signal output timing and defers reception of the bus interconnect 150. The bus interconnect 150 transfers the Ready signal input from the bus slave 130 to the transfer request output unit 115 in the bus master 110; the transfer request output unit 115 maintains signal output until the Ready signal becomes active.

Returning to FIG. 2, the transfer response input unit 116 accepts input of responses from the bus slaves 130 to the command information item output from the transfer request output unit 115. For example, the transfer response input unit 116 receives a write response channel signal WRC or a read data channel signal RDC from the bus interconnect 150, by outputting a Ready signal to the bus interconnect 150. The transfer response input unit 116 then notifies the command queue retention time comparison unit 118 of the transfer ID of the received signal.

The address map storage unit 117 stores address map information that includes transfer target addresses and bus slave numbers of the bus slaves 130 possessing the transfer target addresses.

FIG. 4 is a schematic diagram illustrating an example of the address map information.

The address map information 117a is information that includes a base address column 117b, an upper limit address column 117c, and a bus slave number column 117d in a table format.

The base address column 117b holds a transfer target address that functions as a base address.

The upper limit address column 117c holds a transfer target address that functions as an upper limit address.

The bus slave number column 117d holds the bus slave number of the bus slave 130 to which a transfer target address included between the base transfer target address held in the base address column 117b and the upper limit transfer target address held in the upper limit address column 117c is assigned.

It means that the transfer target address included in a range of addresses specified by the base address column 117b and the upper limit address column 117c is possessed by the bus slave 130 having the bus slave number specified by the bus slave number column 117d of the record. Accordingly, by using the address map information 117a, a bus slave to which the transfer target address is assigned can be identified.

The command queue retention time comparison unit 118 compares retention times measured from when a command information item stored in the command queue 112 is output until a response based on the command information item is obtained, and updates the transfer sequence coherency information stored in the transfer sequence coherency information storage unit 119 so that a command information item directed to the bus slave 130 to which a command information item with a long retention time was sent is output before a command information item directed to another bus slave 130.

For example, by referring to the management information and command information stored in the command queue 112, the command queue retention time comparison unit 118 identifies the transfer target address and queue item number of the command information item for which a response has been received, on the basis of the transfer ID notified from the transfer response input unit 116. The command queue retention time comparison unit 118 then identifies the bus slave 130 possessing the identified transfer target address, by referring to the address map information 117a stored in the address map storage unit 117. Next the command queue retention time comparison unit 118 checks whether or not there is a command information item to which a queue item number smaller than the identified queue item number is assigned and that is still valid, in other words, a command information item that is output earlier than a command information item for which a response has been received and for which no response is yet received. If such a command information item is present, the command queue retention time comparison unit 118 identifies the bus slave 130 that is a transfer destination of the command information item, by referring to the address map information 117a stored in the address map storage unit 117. The command queue retention time comparison unit 118 then updates the transfer sequence coherency information stored in the transfer sequence coherency information storage unit 119 so that a command information item directed to the bus slave 130 identified from a command information item for which no response has been received is output before a command information item directed to the bus slave 130 identified from a command information item for which a response has been received.

The transfer sequence coherency information storage unit 119 stores transfer sequence coherency information including information indicating, for each combination of bus slaves 130, whether responses to output the command information item have arrived in inverse order.

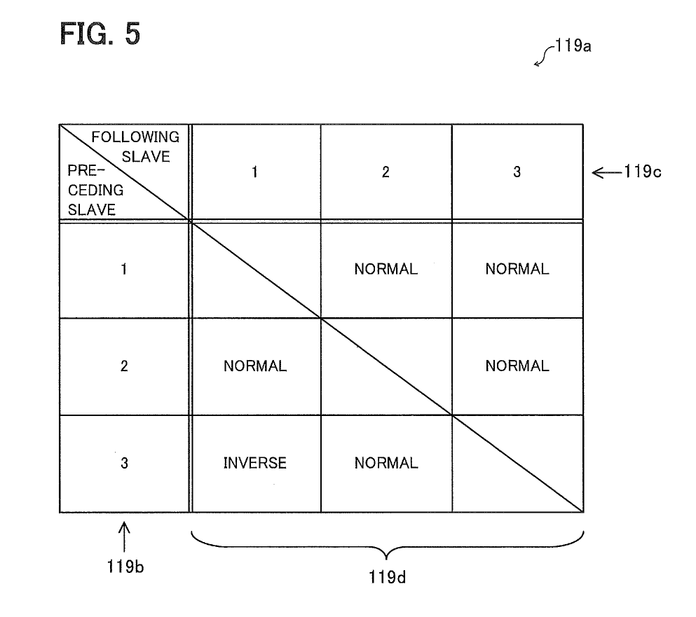

FIG. 5 is a schematic diagram illustrating an example of the transfer sequence coherency information.

The transfer sequence coherency information 119a is information including a preceding slave column 119b and a following slave row 119c in a table format.

The bus slave numbers of the bus slaves 130 connected to the bus interconnect 150 are stored in the cells in the preceding slave column 119b.

The bus slave numbers of the bus slaves 130 connected to the bus interconnect 150 are stored in the cells in the following slave row 119c.

A cell 119d correspond to a bus slave number stored in the preceding slave column 119b and a bus slave number stored in the following slave row 119c stores information indicating a response obtaining order between the bus slave 130 identified by the bus slave number stored in the preceding slave column 119b and the bus slave 130 identified by the bus slave number stored in the following slave row 119c.

For example, the designation ‘normal’ in a cell 119d means that when the command information item directed to the bus slave 130 identified by the bus slave number stored in the corresponding preceding slave column 119b was output earlier and the command information item to the bus slave 130 identified by the bus slave number stored in the corresponding following slave row 119c was output later, the responses were received in the order of output. The designation ‘inverse’ in a cell 119d means that when the command information item directed to the bus slave 130 identified by the bus slave number stored in the corresponding preceding slave column 119b was output earlier and the command information item to the bus slave 130 identified by the bus slave number stored in the corresponding following slave row 119c was output later, the responses were received in the inverse order to the order of output.

Immediately after startup of the bus system 100, the content of the transfer sequence coherency information 119a is initialized to ‘normal’ in every combination.

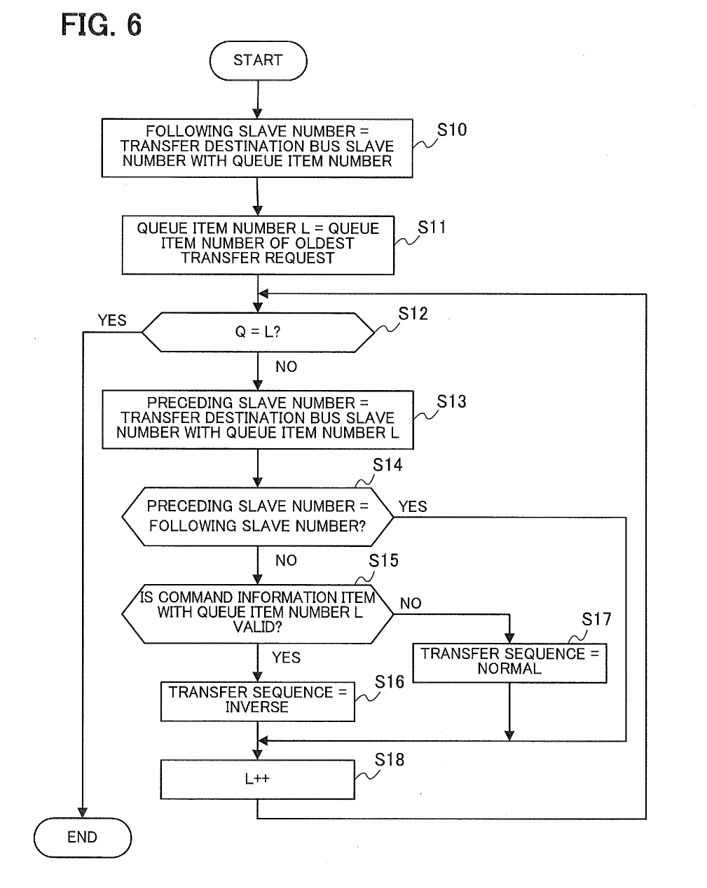

FIG. 6 is a flowchart illustrating a process of updating the transfer sequence coherency information 119a by the command queue retention time comparison unit 118.

Here, the command queue retention time comparison unit 118 identifies a queue item number Q (0≦Q≦(the number of queue items−1)) having the same transfer ID as the transfer ID notified from the transfer response input unit 116, by referring to the command information and management information stored in the command queue 112. Then, in the management information, the command queue retention time comparison unit 118 updates the queue valid/invalid information corresponding to the identified queue item number Q from ‘valid’ to ‘invalid’, and updates the transfer request output information from ‘already’ indicating that it is already output, to ‘not yet’ indicating that it is not yet output, as to the identified queue item number Q. The command queue retention time comparison unit 118 then starts the process flow illustrated in FIG. 6.

First, the command queue retention time comparison unit 118 refers to the address map information stored in the address map storage unit 117, on the basis of the transfer target address with queue item number Q, and thereby obtaining the bus slave number identifying the bus slave 130 that is a transfer destination of the queue item number Q. Then, the command queue retention time comparison unit 118 sets the obtained bus slave number as a following slave number (S10).

Next, in the command queue 112, the command queue retention time comparison unit 118 identifies the queue item number L (0≦L≦(the number of queue items−1)) at which the oldest command information item is stored (S11). The oldest command information item here is the one that was stored earliest in the command queue 112, among the currently stored command information items.

Next, the command queue retention time comparison unit 118 compares the queue item numbers Q and L and checks whether Q and L are equal or not (S12). If Q and L are equal (S12; Yes), there is no command information item stored earlier, so the command queue retention time comparison unit 118 does not update the transfer sequence coherency information and terminates the process flow. If Q and L are not equal (S12; No), the process proceeds to step S13.

In step S13, the command queue retention time comparison unit 118 refers to the address map information stored in the address map storage unit 117, on the basis of the transfer target address with queue item number L, and thereby obtaining the bus slave number for identifying the bus slave 130 that is a transfer destination of the queue item number L. The command queue retention time comparison unit 118 sets the obtained bus slave number as a preceding slave number (S13).

Next, the command queue retention time comparison unit 118 then compares the preceding slave number and the following slave number and determines whether they are the same or not (S14). If they are the same (S14; Yes), the process proceeds to step S18; if they are not the same (S14; No), the process proceeds to step S15.

In step S15, the command queue retention time comparison unit 118, by referring to the management information stored in the command queue 112, determines whether a command information item with queue item number L is ‘valid’ or not. If the command information item with queue item number L is ‘valid’ (S15; Yes), the process proceeds to step S16; if the command information item with queue item number L is ‘invalid’ (S15; No), the process proceeds to step S17.

In step S16, since the following slave is followed by the preceding slave in the transfer response input sequence, the transfer request (command information) output sequence and the transfer response input sequence do not correspond. The command queue retention time comparison unit 118 therefore updates the value in the corresponding cell 119d in the transfer sequence coherency information 119a stored in the transfer sequence coherency information storage unit 119 to ‘inverse’. The process then proceeds to step S18.

On the other hand, in step S17, since the preceding slave is followed by the following slave in the transfer response input sequence, the command queue retention time comparison unit 118 updates the value in the corresponding cell 119d in the transfer sequence coherency information 119a stored in the transfer sequence coherency information storage unit 119 to ‘normal’. The process then proceeds to step S18.

In step S18, the command queue retention time comparison unit 118 increments queue item number L by ‘1’ and the process returns to step S12. Then, the command queue retention time comparison unit 118 repeats processing of steps S12 to S18 until queue item number L corresponds to queue item number Q.

For example, suppose that the command information and management information stored in the command queue 112 are the information shown in FIG. 3. If the command information items are output in an order from queue item numbers ‘0’ to ‘3’ and the transfer response input sequence is an order of ‘0’, ‘1’, ‘3’ and ‘2’, a transfer response from the bus slave 130A with following slave number ‘1’ is input earlier than that from the bus slave 130C with preceding slave number ‘3’. In this case, the transfer sequence coherency information 119a is updated, as shown in FIG. 6: the value in the cell 119d corresponding to the combination of preceding slave number ‘3’ (bus slave #3) and following slave number ‘1’ (bus slave #1) is updated to ‘inverse’; the values in the cells 119d corresponding to the other combinations are updated to ‘normal’.

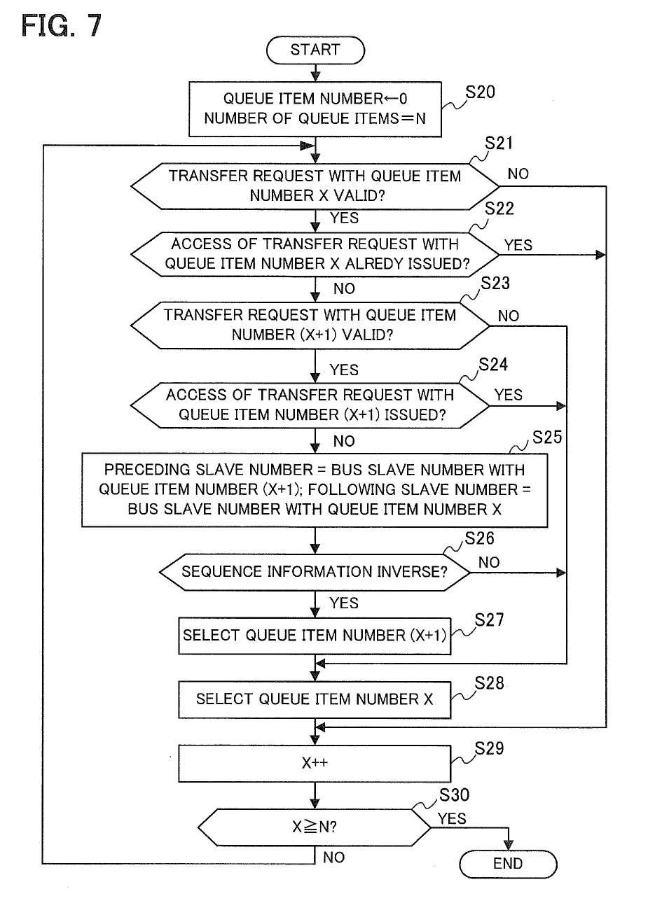

FIG. 7 is a flowchart illustrating a process when the transfer request output sequence control unit 114 refers to the transfer sequence coherency information 119a, and selects a command information item with any one of the queue item numbers stored in the command queue 112.

The transfer request output sequence control unit 114 first searches in an order from queue item number ‘0’ for a queue item number X whose queue status is valid and transfer request is not yet output (S20 to S22).

Specifically, the transfer request output sequence control unit 114 sets the smallest value of queue item number ‘0’ as queue item number X and sets the number of the command information items that can be stored in the command queue 112 as the number of queue items N (S20). Here, in the example shown in FIG. 3, the number of queue items N is ‘4’.

The transfer request output sequence control unit 114 then refers to the management information stored in the command queue 112 and determines whether the command information item with queue item number X is ‘valid’ or not (S21). If the command information item with queue item number X is ‘valid’ (S21; Yes), the process proceeds to step S22; if the command information item with queue item number X is ‘invalid’ (S21; No), the process proceeds to step S29.

In step S22, the transfer request output sequence control unit 114 refers to the management information stored in the command queue 112 and determines whether the command information item with queue item number X has already been output. If the command information item with queue item number X has already been output (S22; Yes), the process proceeds to step S29; if the command information item with queue item number X has not been output (S22; No), the process proceeds to step S23.

In step S23, the transfer request output sequence control unit 114 determines whether the command information item with queue item number (X+1) is ‘valid’ or not. If the command information item with queue item number (X+1) is ‘valid’ (S23; Yes), the process proceeds to step S24; if the command information item with queue item number (X+1) is ‘invalid’ (S23; No), the process proceeds to step S28.

If queue item number (X+1) is equal to or greater than the number of queue items N, queue item number (X+1) returns to queue item number ‘0’ (=X+1−N). This also holds true in the following steps.

In step S24, the transfer request output sequence control unit 114 refers to the management information stored in the command queue 112 and determines whether the command information item with queue item number (X+1) has already been output or not. If the command information item with queue item number (X+1) has already been output (S24; Yes), the process proceeds to step S28; if the command information item with queue item number (X+1) has not yet been output (S24; No), the process proceeds to step S25.

In step S25, the transfer request output sequence control unit 114 refers to the management information stored in the command queue 112 and identifies the transfer target addresses with queue item number X and queue item number (X+1). The transfer request output sequence control unit 114 refers to the address map information 117a stored in the address map storage unit 117 and obtains the bus slave numbers corresponding to the transfer target addresses with queue item number X and queue item number (X+1). The transfer request output sequence control unit 114 sets the bus slave number with queue item number (X+1) as a preceding slave number and the bus slave number with queue item number X as a following slave number.

The transfer request output sequence control unit 114 then refers to the transfer sequence coherency information 119a and checks whether a relationship between the transfer request output sequence and transfer response input sequence in the combination of the preceding slave number and following slave number identified in step S25 is ‘inverse’ or not (S26). If the check result indicates ‘inverse’ (S26; Yes), the process proceeds to step S27; if the check result indicates ‘normal’ (S26; No), the process proceeds to step S28.

In step S27, the transfer request output sequence control unit 114 supplies the command information item with queue item number (X+1) to the transfer request output unit 115 to have the transfer request output unit 115 output the command information item. The process then proceeds to step S28.

In step S28, the transfer request output sequence control unit 114 supplies the command information item with queue item number X to the transfer request output unit 115 to have the transfer request output unit 115 output the command information item. The process then proceeds to step S29.

In other words, if the relationship between the transfer request output sequence and transfer response input sequence is ‘inverse’, the command information item with queue item number X is output after the command information item with queue item number (X+1) is output. If the relationship between the transfer request output sequence and transfer response input sequence is ‘normal’, the command information item with queue item number X is output.

The transfer request output sequence control unit 114 then increments queue item number X by ‘1’ (S29). The transfer request output sequence control unit 114 checks whether queue item number X is equal to or greater than the number of queue items N (S30). If queue item number X is equal to or greater than the number of queue items N (S30; Yes), the transfer request output sequence control unit 114 terminates the process flow. If queue item number X is smaller than the number of queue items N (S30; No), the process returns to step S21. When the process flow is terminated, the transfer request output sequence control unit 114 starts the process flow of FIG. 7 again.

According to the flowchart shown in FIG. 7, when a bus slave possessing a transfer target address included in the command information item stored first is set as the preceding slave, a bus slave possessing a transfer target address included in the command information item stored next is set as the following slave, among the command information items stored in the command queue 112, and information indicating that the responses are reversed is included in the transfer sequence coherency information 119a, the transfer request output sequence control unit 114 can select the command information item stored next as the output target command information item before the command information item stored first.

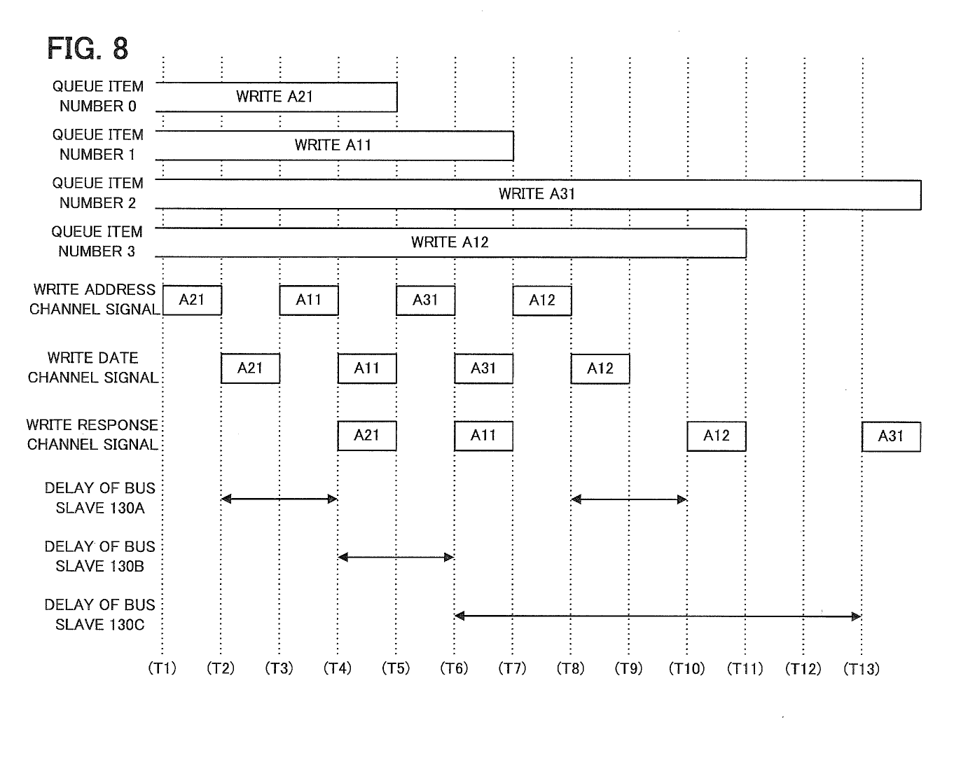

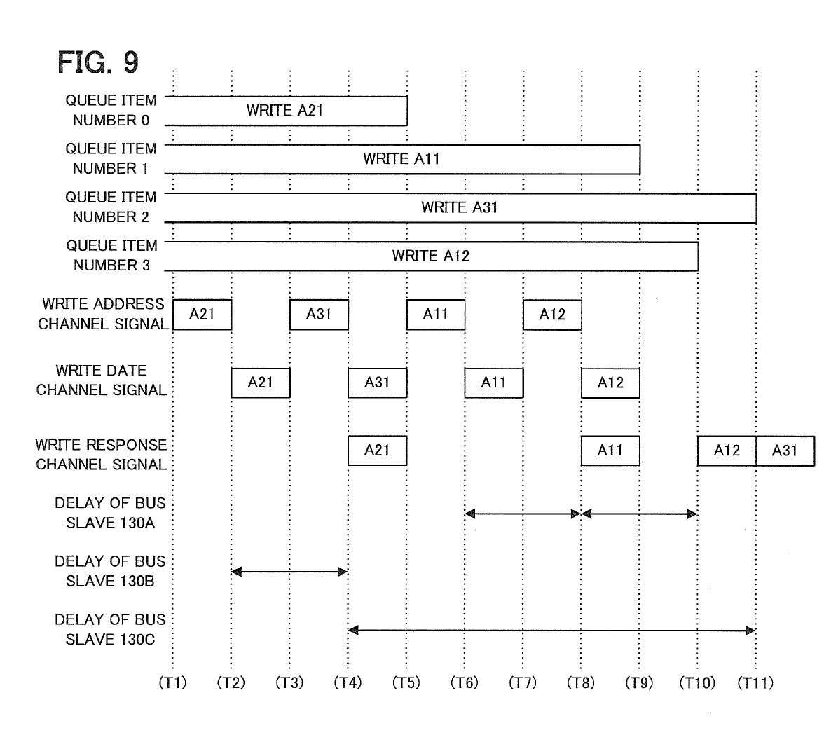

The difference in operation of the bus master 110 in the bus system 100 according to the first embodiment before and after the transfer sequence coherency information is updated will be described with reference to FIGS. 8 and 9. FIG. 8 is a timing diagram illustrating operation before the transfer sequence coherency information is updated, in other words, when the values of all the cells of the transfer sequence coherency information indicate ‘normal’. FIG. 9 is a timing diagram illustrating operation after the transfer sequence coherency information is updated, in other words, when the transfer sequence coherency information is as the transfer sequence coherency information 119a shown in FIG. 5. Both FIGS. 8 and 9 illustrate a case where the bus master 110 orderly processes data transfers to the plurality of bus slaves 130 on the basis of the command information and management information shown in FIG. 3, which are stored in the command queue 112.

In FIGS. 8 and 9, times (T1) to (T13) are evenly spaced at regular unit time intervals. The write address channel signal WAC and write data channel signal WDC are output from the bus master at identical time intervals. In FIGS. 8 and 9, the time required until transfer responses from the bus slave 130A and the bus slave 130B are obtained is two unit times; the time required until a transfer response from the bus slave 130C is obtained is seven unit times.

The values in all the cells of the transfer sequence coherency information are initialized to ‘normal’ immediately after the startup or immediately after a reset of the bus system 100. In the state in which the transfer sequence coherency information is initialized, the transfer request output sequence control unit 114 extracts the transfer types, transfer target addresses, and transfer data lengths in the order in which they are stored in the command queue 112 and supplies them to the transfer request output unit 115. If the information stored in the command queue 112a is as shown in FIG. 3, the transfer request output unit 115 issues the write address channel signals WAC at time (T1), time (T3), time (T5), and time (T7) and the write data channel signals WDC at time (T2), time (T4), time (T6), and time (T8) to transfer target address A21, transfer target address A11, transfer target address A31, and transfer target address A12 respectively.

Transfer target address A11 and transfer target address A12 have values equal to or greater than base address A1S but smaller than upper limit address A1E in the address map information shown in FIG. 4, so they are transfer target addresses possessed by the bus slave 130A with bus slave number ‘1’. Transfer target address A21 is a transfer target address possessed by the bus slave 130B with bus slave number ‘2’. Transfer target address A31 is a transfer target address possessed by the bus slave 130C with bus slave number ‘3’.

The response to the transfer request to address A31 stored with queue item number 2 in the command queue 112, or the response to the transfer request to the bus slave 130C, is obtained at time (T13) after seven unit times from time (T6) at which the transfer request was issued. On the other hand, the time required until a transfer response is obtained to the transfer request to address A12 stored with queue item number 3, or the bus slave 130A, is shorter than that for the bus slave 130C, and the transfer response is obtained at time (T10) after two unit times from time (T8).

When obtaining the transfer response from the bus slave 130A corresponding to queue item number 3 at time (T10), the command queue retention time comparison unit 118 requests the transfer destination slave numbers in order starting from queue item number 0. In this case, the command queue retention time comparison unit 118 sets the bus slave number ‘1’ of the bus slave 130A as a following slave number. Since a command information item directed to the bus slave 130B (bus slave number ‘2’) is stored with queue item number 0, bus slave number ‘2’ is set as a preceding slave number (step S13 in FIG. 6). Because the preceding slave number ‘2’ differs from the following slave number ‘1’, the command queue retention time comparison unit 118 checks whether the command information item with queue item number 0 is ‘valid’ or ‘invalid’ (step S15 in FIG. 6). The transfer response to the command information item with queue item number 0 has already been input at time (T4), and the command information item with queue item number 0 is made invalid at time (T10). Since the bus slave 130B with the preceding slave number comes earlier than the bus slave 130C with the following slave number in the transfer response input order of queue item number 0 and queue item number 3, the transfer request output sequence and the transfer response input sequence correspond. Therefore, the command queue retention time comparison unit 118 updates the value of the corresponding cell in the transfer sequence coherency information to ‘normal’ (step S17 in FIG. 6).

The transfer destination bus slave with queue item number 1 is the bus slave 130A of bus slave ‘1’, the same as queue item number 3 (Yes in step S14 in FIG. 6), so the command queue retention time comparison unit 118 does not update the transfer sequence coherency information.

Next, the transfer destination bus slave with queue item number 2 is the bus slave 130C with bus slave number ‘3’, and it remains queue valid state at time T10. Accordingly, since the bus slave 130A with the following slave number is followed by the bus slave 130C with the preceding slave number in the transfer response input sequence and the transfer request output sequence and the transfer response input sequence do not correspond, the command queue retention time comparison unit 118 updates the value in the corresponding cell of the transfer sequence coherency information to ‘inverse’ (step S16 in FIG. 6). As in the transfer sequence coherency information 119a shown in FIG. 5, the transfer sequence coherency information updated at time (T10) indicates ‘inverse’ only for the combination of preceding slave number ‘3’ and following slave number ‘1’.

Next, the operation of the bus master 110 after the transfer sequence coherency information is updated to the transfer sequence coherency information 119a shown in FIG. 5 will be described with reference to FIG. 9.

Since the oldest command information item with queue item number 0 and the next oldest command information item with queue item number 1 are ‘valid’ among the command information items stored in the command queue 112, and they are in a state where their transfer requests are not yet output, the transfer request output sequence control unit 114 obtains bus slave number ‘2’ and bus slave number ‘1’ which are their respective transfer destination bus slaves. Then, the transfer request output sequence control unit 114 sets bus slave number ‘2’ as a following slave number and bus slave number ‘1’ as a preceding slave number (step S25 in FIG. 7). Then referring to the transfer sequence coherency information 119a, the transfer request output sequence control unit 114 confirms that the combination of preceding slave number ‘1’ and following slave number ‘2’ is ‘normal’ (No in step S26), and selects queue item number 0 at first, in accordance with an storing order in the command queue 112 (step S28 in FIG. 7). The transfer request output sequence control unit 114 then has the transfer request output unit 115 output a write address channel signal WAC to transfer target address A21 at time (T1).

Next, referring to the command information and management information stored in the command queue 112, the transfer request output sequence control unit 114 confirms that queue item number 1 and queue item number 2 are ‘valid’ and that the corresponding transfer requests are not output yet, and sets bus slave number ‘3’, which is the transfer destination bus slave with queue item number 2, as a preceding slave number and bus slave number ‘1’, which is the transfer destination bus slave with queue item number 1, as a following slave number (step S25 in FIG. 7). Then, referring to the transfer sequence coherency information 119a, since the combination of the preceding slave number ‘3’ and the following slave number ‘1’ is ‘inverse’, the transfer request output sequence control unit 114 decides that the time required to obtain a transfer response from the bus slave 130C is longer than time required to obtain a transfer response from the bus slave 130A. Accordingly, the transfer request output sequence control unit 114 selects queue item number 2 earlier and supplies it to the transfer request output unit 115. The transfer request output sequence control unit 114 has the transfer request output unit 115 output a write address channel signal WAC to transfer target address A31 at time (T3). The transfer request output sequence control unit 114 then selects queue item number 1 and has the transfer request output unit 115 output a write address channel signal WAC to transfer target address A11 at time (T5).

Finally, since the command information item with queue item number 0, at which a transfer request is stored next to queue item number 3, is ‘invalid’ (No in step S23 in FIG. 7), the transfer request output sequence control unit 114 selects queue item number 3. The transfer request output sequence control unit 114 then has the transfer request output unit 115 output a write address channel signal WAC to address A12 at time (T7).

Here, as shown in FIG. 9, the response to the transfer request to address A31 stored with queue item number 2, or the transfer request to the bus slave 130C (bus slave number ‘3’), is obtained at time (T11) after seven unit times from the time (T4) as a time of output of the transfer request. Accordingly, in comparison with the operation with the initialized transfer sequence coherency information illustrated in FIG. 8, the time required to complete the transfer request process is reduced by two unit times.

In the first embodiment, the output sequence of transfer requests to the bus slaves 130A to 130C and the transfer response input sequence are monitored, and bus slaves 130 that require a long time to return a transfer response are identified among the bus slaves 130. On the basis of the results of these identifications between bus slaves 130 to which a consecutive sequence of transfer request command information items are directed, the bus master 110 outputs transfer requests to bus slaves 130 that require a long time to return a transfer response before outputting transfer requests to another bus slaves 130. This advances the times at which transfer responses are obtained from these bus slaves 130 and shortens the command queue retention time of their transfer requests, in comparison with issuing transfer requests in their order in the command queue. The bus master 110 can shorten the time required to complete the processing of the transfer requests enqueued in the command queue and can perform efficient data transfer.

If the transfer processing time in some bus slave 130 is temporarily lengthened because of DRAM refreshing, temporary external power supply or clock stoppage, or transfer overload, for example, transfer requests to that bus slave 130 are output earlier than transfer requests to another bus slaves 130. Even if the bus slave 130 later returns to its normal state and does not require early output of transfer requests, the first embodiment is configured so that the command queue retention time comparisons continue and the transfer sequence coherency information is updated. Therefore, bus transfers suited to the operation of the bus slaves 130 can be performed without continuing unnecessary rearrangement of the transfer request output sequence.

### Second Embodiment

As shown in FIG. 1, in a bus system 200 according to the second embodiment, bus masters 210A-210C (referred to as bus masters 210 when it is not particularly necessary to distinguish among them) and bus slaves 130A-130C (referred to as bus slaves 130 when it is not particularly necessary to distinguish among them) are interconnected through a bus interconnect 150. The bus system 200 according to the second embodiment differs from the bus system 100 according to the first embodiment in regard to the bus masters 210.

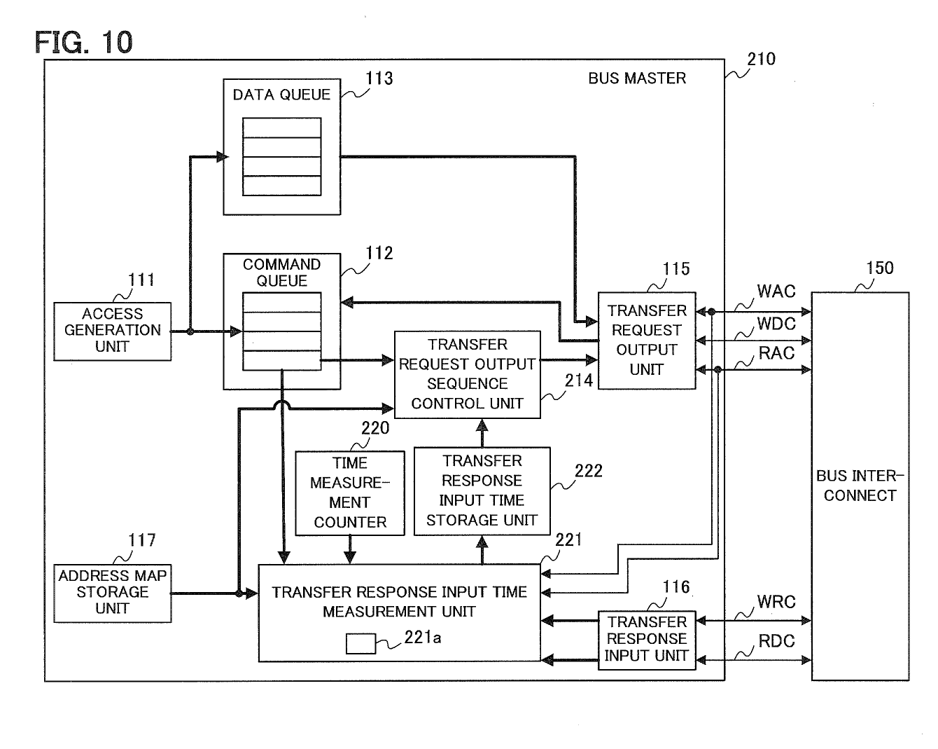

FIG. 10 is a block diagram schematically illustrating the configuration of a bus master 210 in the second embodiment. The bus master 210 includes an access generation unit 111, a command queue 112, a data queue 113, a transfer request output sequence control unit 214, a transfer request output unit 115, a transfer response input unit 116, an address map storage unit 117, a time measurement counter 220, a transfer response input time measurement unit 221, and a transfer response input time storage unit 222. The bus master 210 in the second embodiment differs from the bus master 110 in the first embodiment in the processing in the transfer request output sequence control unit 214 and in having the time measurement counter 220, transfer response input time measurement unit 221, and transfer response input time storage unit 222 instead of the command queue retention time comparison unit 118 and transfer sequence coherency information storage unit 119 in the first embodiment.

The time measurement counter 220 performs counting with a predetermined periodicity, thereby generating a count value for measuring time. The time measurement counter 220 furnishes the measured count value to the transfer response input time measurement unit 221.

The transfer response input time measurement unit 221 measures the time from output of a transfer request to input of the response to the request, as a transfer response input time.

For example, when the transfer request output unit 115 outputs a read address channel signal RAC or a write address channel signal WAC, the transfer response input time measurement unit 221 refers to the address map information 117a stored in the address map storage unit 117 and identifies the bus slave number of the bus slaves 130 that is the transfer destination on the basis of the transfer target address. The transfer response input time measurement unit 221 also refers to the command information stored in the command queue 112 and obtains the transfer type and transfer data length corresponding to the transfer ID of the read address channel signal RAC or write address channel signal WAC output by the transfer request output unit 115. From the time measurement counter 220, the transfer response input time measurement unit 221 further obtains the count value at which the transfer request output unit 115 output the read address channel signal RAC or write address channel signal WAC. The transfer response input time measurement unit 221 then stores the transfer ID of the read address channel signal RAC or write address channel signal WAC output by the transfer request output unit 115 in a memory 221a, together with the identified bus slave number, obtained transfer type, obtained transfer data length, and obtained count value. When the transfer response input unit 116 later reports the transfer ID of the read data channel signal RDC or write response channel signal WRC, the transfer response input time measurement unit 221 obtains the count value from the time measurement counter 220. The transfer response input time measurement unit 221 calculates the transfer response input time for the transfer destination bus slave 130 by subtracting the count value at which the transfer request with the reported transfer ID was output, which is stored in the memory 221a, from the count value obtained when the transfer ID is reported.

The transfer response input time measurement unit 221 updates the transfer response input time information stored in the transfer response input time storage unit 222 on the basis of the calculated transfer response input time and the corresponding bus slave number, transfer type, and transfer data length. For example, if the corresponding bus slave number, transfer type, and transfer data length have already been stored in the transfer response input time information, the transfer response input time measurement unit 221 deletes the stored transfer response input time and stores the newly calculated transfer response input time. If the corresponding bus slave number, transfer type, and transfer data length have not been stored in the transfer response input time information, the transfer response input time measurement unit 221 stores this information and the newly calculated transfer response input time.

If the input signal is a read data channel signal RDC, the transfer response input unit 116 waits until as many read data channel signals RDC as the transfer data length have been input and then reports the transfer ID to the transfer response input time measurement unit 221.

The transfer response input time storage unit 222 stores the transfer response input time measured by the transfer response input time measurement unit 221 for each bus slave 130. Here, the transfer response input time is, for each bus slave 130, the time from the output of the read address channel signal RAD to the input of the read data channel signal RDC (the last read data channel signal RDC for a burst read) or the time from the output of the write address channel signal WAC to the input of the write response channel signal WRC; the time value is expressed in terms of the measurement precision of the time measurement counter 220.

The transfer response input time stored for each bus slave 130 generally differs depending on whether the operation is a write operation or a read operation, so write times and read times may be stored separately. If burst transfers are permitted, the transfer response input time varies with the quantity of data transferred, so separate transfer response input times may be stored for each quantity of transferred data.

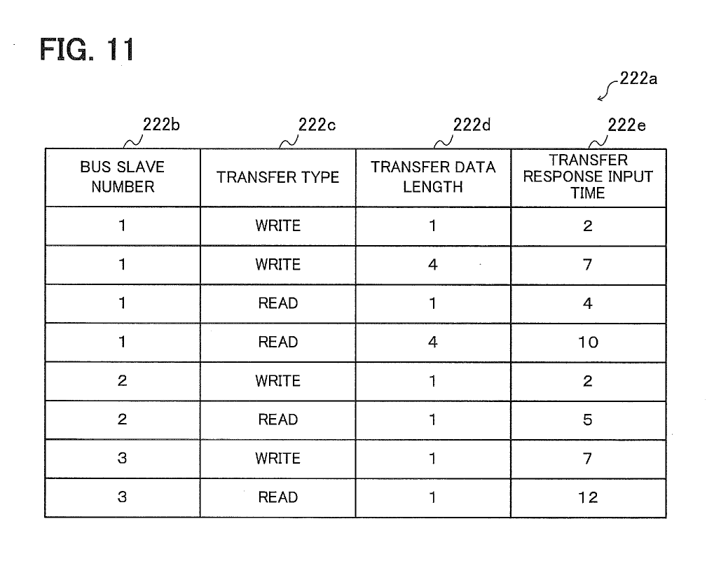

FIG. 11 is a schematic diagram showing exemplary transfer response input time information stored in the transfer response input time storage unit 222. As shown in FIG. 11, the transfer response input time information 222a is a table of information having a bus slave number column 222b in which the bus slave number is stored, a transfer type column 222c in which the transfer type is stored, a transfer data length column 222d in which the transferred data length is stored, and a transfer response input time column 222e in which the transfer response input time is stored. The transfer response input time information 222a shown in FIG. 11 stores transfer response input times classified by read or write transfer type and burst length for each transfer destination slave.

The transfer request output sequence control unit 214 controls the sequence in which a command information item stored in the command queue 112 is sent by selecting output target command information item in accordance with the transfer response input time information 222a. For example, the transfer request output sequence control unit 214 outputs a command information item for transfer request to a bus slave 130 that has a long transfer response input time before outputting a command information item for transfer request to another bus slave 130. More specifically, the transfer request output sequence control unit 214 refers to the transfer response input time information 222a, obtains the transfer type, the transfer data length, and the transfer response input time of the bus slave number of the transfer destination bus slave 130 corresponding to the oldest command information item stored in the command queue 112, and sets the transfer response input time as the response time of a preceding bus slave. The transfer request output sequence control unit 214 then refers to the transfer response input time information 222a, obtains the transfer type, the transfer data length, and the transfer response input time of the bus slave number of the transfer destination bus slave 130 corresponding to the second oldest stored command information item, and sets the transfer response input time as the response time of the following bus slave.

If the response time of the preceding bus slave is shorter than the response time of the following bus slave, the transfer request output sequence control unit 214 selects the queue item number at which the oldest command information item is stored. If the response time of the preceding bus slave is greater than or equal to the response time of the following bus slave, the transfer request output sequence control unit 214 selects the queue item number at which the second oldest command information item is stored. The transfer request output sequence control unit 214 then supplies the command information item with the selected queue item number to the transfer request output unit 115. The transfer request output unit 115 generates a read address channel signal RAC or a write address channel signal WAC 103 in accordance with the supplied command information item and outputs the generated signal. After output of the generated signal, the transfer request output sequence control unit 214 updates the transfer request output information of the selected queue item number from not yet output to already output.

In other words, the transfer request output sequence control unit 214 in the second embodiment refers to the transfer response input times stored in the transfer response input time storage unit 222, and when, among the command information items stored in the command queue 112, the transfer response input time of a bus slave possessing a transfer target address included in the command information item stored first is shorter than the transfer response input time of a bus slave possessing a transfer target address included in the command information item stored next, the transfer request output sequence control unit 214 can select the command information item stored next as the output target command information item before selecting the command information item stored first.

In the second embodiment, the bus master 210 stores the time taken to receive a transfer response, outputs a transfer request to a bus slave 130 with a long transfer time earlier than a transfer request to another bus slave 130 to advance its transfer completion time, and can thereby perform efficient data transfer.

### Third Embodiment

As shown in FIG. 1, in the bus system 300 according to the third embodiment, bus masters 310A-310C (referred to as bus masters 310 when it is not particularly necessary to distinguish among them) and bus slaves 130A-130C (referred to as bus slaves 130 when it is not particularly necessary to distinguish among them) are interconnected through a bus interconnect 150. The bus system 300 according to the third embodiment differs from the bus system 200 according to the second embodiment in regard to the bus masters 310.

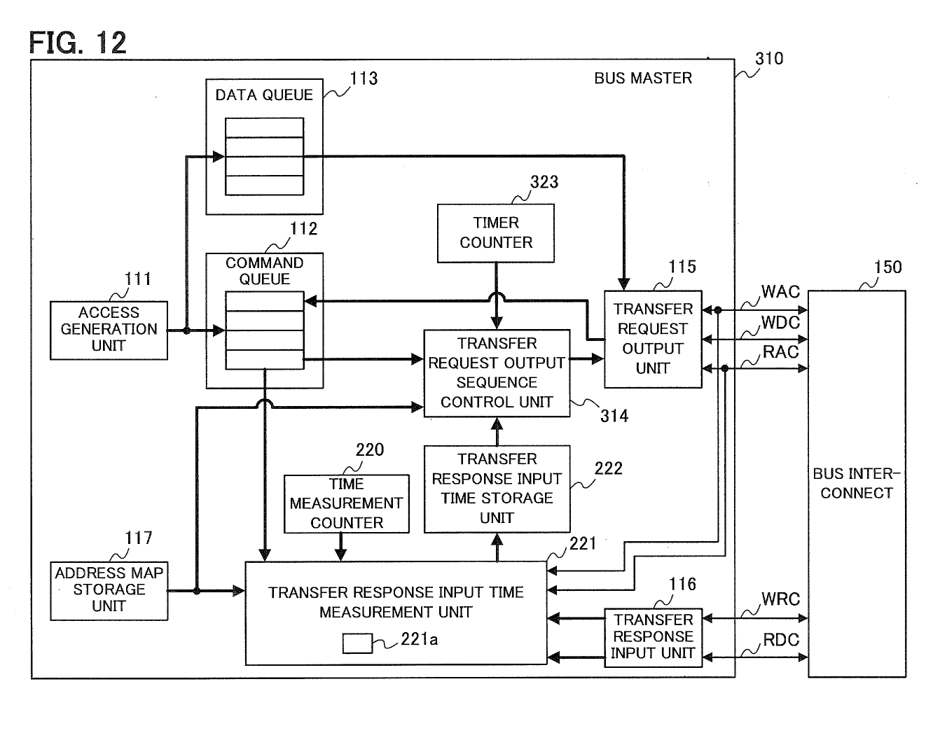

FIG. 12 is a block diagram schematically illustrating the configuration of a bus master 310 in the third embodiment. The bus master 310 includes an access generation unit 111, a command queue 112, a data queue 113, a transfer request output sequence control unit 314, a transfer request output unit 115, a transfer response input unit 116, an address map storage unit 117, a time measurement counter 220, a transfer response input time measurement unit 221, a transfer response input time storage unit 222, and a timer counter 323. The bus master 310 in the third embodiment differs from the bus master 210 in the second embodiment in the processing in the transfer request output sequence control unit 314 and also in having the timer counter 323.

The timer counter 323 performs counting with a predetermined periodicity on instruction from the transfer request output sequence control unit 314, thereby generating a count value for measuring time. The timer counter 323 supplies the measured count value to the transfer request output sequence control unit 314.

When it refers to the command queue 112, the transfer request output sequence control unit 314 has the timer counter 323 start counting. The transfer request output sequence control unit 314 also refers to the transfer response input time information 222a stored in the transfer response input time storage unit 222 and obtains transfer response input times corresponding to the access type, burst length, and transfer destination bus slave 130 of all the command information items stored in the command queue 112. The transfer request output sequence control unit 314 then sets the transfer destination bus slave 130 of the oldest command information item among the command information items with not-yet-output transfer request output information as the preceding slave and sets the transfer destination bus slaves 130 of each command information item stored after the oldest command information item as following slaves. The transfer request output sequence control unit 314 calculates a value Trev for each of all the following slaves by formula (1) below

Trev=FRT−(PRT+TT) (1)

where FRT is the transfer response input time of the following slave and PRT is the transfer response input time of the preceding slave. TT is the count value of the timer counter 323.

If the Trev value calculated by formula (1) is greater than ‘0’ for a following slave, the transfer request output sequence control unit 314 selects the queue item number at which the command information item directed to that following slave is stored. If the Trev value calculated by formula (1) is greater than ‘0’ for a plurality of following slaves, the transfer request output sequence control unit 314 selects the queue item number corresponding to the largest Trev value among them. If there is no queue item number satisfying Trev>0, the transfer request directed to the preceding slave is selected.

The transfer request output sequence control unit 314 then supplies the command information item of the selected queue item number to the transfer request output unit 115. The transfer request output unit 115 generates a read address channel signal RAC or a write address channel signal WAC in accordance with the content of the supplied command information item and outputs the generated signal. After the output of the generated signal, the transfer request output sequence control unit 314 updates the transfer request output information with the selected queue item number from not yet output to already output.

In this embodiment, the timer counter 323 and time measurement counter 220 are assumed to have the same measurement precision. If the timer counter 323 and time measurement counter 220 have different measurement precisions, the Trev value is calculated by formula (1) in terms of one measurement precision or the other.

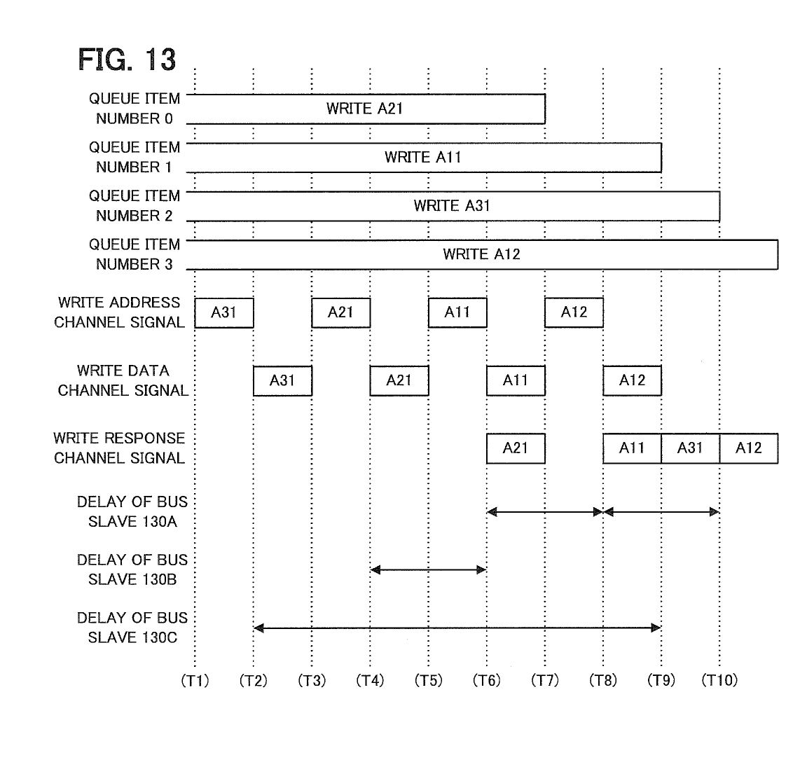

The operation of the bus master 310 in the bus system 300 according to the third embodiment will be described with reference to FIG. 13. The time required to obtain a transfer response from the bus slave 130 in FIG. 13 is the same as in FIGS. 8 and 9: The time required to obtain a transfer response from bus slave 130A (bus slave number ‘1’) and bus slave 130B (bus slave number ‘2’) is two unit times; the time required to obtain a transfer response from bus slave 130C (bus slave number ‘3’) is seven unit times. FIG. 13 is a timing diagram illustrating the operation of the bus master 310 when the transfer response input times of the bus slaves 130 are the transfer response input times stored in the transfer response input time information 222a shown in FIG. 11. It is assumed here that the measurement precision of the timer counter 323 and the time measurement counter 220 equals one unit time in the series of times T1 to T10 shown in FIG. 13.

At time T1, the transfer request output sequence control unit 314 refers to the transfer response input time information 222a and obtains two unit times as the transfer response input time corresponding to transfer destination bus slave 130B (bus slave number ‘2’), transfer type ‘write’, and transfer data length ‘1’ in the command information item with queue item number ‘0’ shown in FIG. 3. The transfer response input time PRT of the preceding slave is set to two unit times. In the same way, the transfer request output sequence control unit 314 also obtains two unit times as the transfer response input time corresponding to transfer destination bus slave 130A (bus slave number ‘1’), transfer type ‘write’, and transfer data length ‘1’ in the command information item with queue item number ‘1’. Therefore, the transfer response input time FRT of the following slave corresponding to queue item number ‘1’ is ‘2’. In the same way, the transfer request output sequence control unit 314 further obtains seven unit times as the transfer response input time corresponding to transfer destination bus slave 130C (bus slave number ‘3’), transfer type ‘write’, and transfer data length ‘1’ in the command information item with queue item number ‘2’. Therefore, the transfer response input time FRT of the following slave corresponding to queue item number ‘2’ is ‘7’. In the same way, the transfer request output sequence control unit 314 moreover obtains two unit times as the transfer response input time corresponding to transfer destination bus slave 130A (bus slave number ‘1’), transfer type ‘write’, and transfer data length ‘1’ in the command information item with queue item number ‘3’. Therefore, the transfer response input time FRT of the following slave corresponding to queue item number ‘3’ is ‘2’.

The transfer request output sequence control unit 314 issues an instruction to the timer counter 323 to start counting from ‘0’. Since the transfer response input time PRT of the preceding slave is ‘2’ and the count value of the timer counter 323 is ‘0’, at time T1, the transfer request output sequence control unit 314 checks whether any queue item number satisfies formula (2) below on the basis of formula (1) above, by using the FRT values of queue item numbers ‘1’ to ‘3’.

Trev=FRT−(2+0)>0 (2)

In the example described above, since the transfer response input time of the following slave corresponding to queue item number ‘2’ is ‘7’ and satisfies formula (2), the transfer request output sequence control unit 314 selects queue item number ‘2’ at time T1. The transfer request output unit 115 outputs a write address channel signal WAC in accordance with the command information item with queue item number ‘2’ on the basis of the selection result made by the transfer request output sequence control unit 314 and then updates the transfer response output information with queue item number ‘2’ from not yet output to already output.

At time T3, as at time T1, the oldest command information item is the command information item with queue item number ‘0’. The transfer request output sequence control unit 314 sets the transfer response input time PRT of the preceding slave to ‘2’ and the count value of the timer counter 323 to ‘3’ and checks whether any queue item number satisfies formula (3) below by using the FRT values of queue item numbers ‘1’ and ‘3’ on the basis of formula (1) above.

Trev=FRT−(2+3)>0 (3)

In the example shown in FIG. 3, since there is no queue item number for which formula (3) is satisfied and for which the transfer request output information is not yet output, the transfer request output sequence control unit 314 selects queue item number ‘0’ at time 3. On the basis of the selection result made by the transfer request output sequence control unit 314, the transfer request output unit 115 outputs a write address channel signal WAC in accordance with the command information item with queue item number ‘0’ and then updates the transfer request output information with queue item number ‘0’ from not yet output to already output.

At time T5, the oldest command information item is the command information item with queue item number ‘1’. The transfer request output sequence control unit 314 sets the transfer response input time PRT of the preceding slave to ‘2’ and the count value of the timer counter 323 to ‘5’ and uses the FRT of queue item number ‘3’ to check whether formula (4) below is satisfied, on the basis of formula (1) above.

Trev=FRT−(2+5)>0 (4)

In the example shown in FIG. 3, queue item number ‘3’ does not satisfy formula (4), so the transfer request output sequence control unit 314 selects queue item number ‘1’ at time T5. On the basis of the selection result made by the transfer request output sequence control unit 314, the transfer request output unit 115 outputs a write address channel signal WAC in accordance with the command information item with queue item number ‘1’ and then updates the transfer request output information with queue item number ‘1’ from not yet output to already output.

At time T7, the transfer request output sequence control unit 314 selects queue item number ‘3’. On the basis of the selection result made by the transfer request output sequence control unit 314, the transfer request output unit 115 outputs a write address channel signal WAC in accordance with the command information item with queue item number ‘3’ and then updates the transfer request output information with queue item number ‘3’ from not yet output to already output.

As shown in FIG. 13, the transfer responses to the transfer requests output at times T1, T3, T5, and T7 are input at times T9, T6, T8, and T10, respectively. In the example shown in FIG. 13, the time required to finish processing the transfer requests is reduced by three unit times, in comparison with FIG. 8 described in the first embodiment.

As descried above, the transfer request output sequence control unit 314 in the third embodiment refers to the transfer response input times stored in the transfer response input time storage unit 222 and if the transfer response input time of the bus slave possessing the transfer target address included in any one command information item except the command information item stored first, among the command information items stored in the command queue 112, is longer than the sum of the transfer response input time of the bus slave possessing the transfer target address included in the command information item stored first and the elapsed time from a predetermined time, that a command information item can be selected as the output target command information item before the command information item stored first.

The bus system 300 according to the third embodiment can output a transfer request to a bus slave with a longer transfer time earlier than transfer requests to other bus slaves to advance its transfer completion time, and can thereby perform bus master data transfers efficiently.

Since the bus system 300 according to the third embodiment compares the response times of the preceding slave and following slaves stored in the command queue, with consideration given to the elapsed time from the initiation of the comparison, it can avoid having the transfer to a preceding slave finish later than the transfer to a following slave.

### Fourth Embodiment

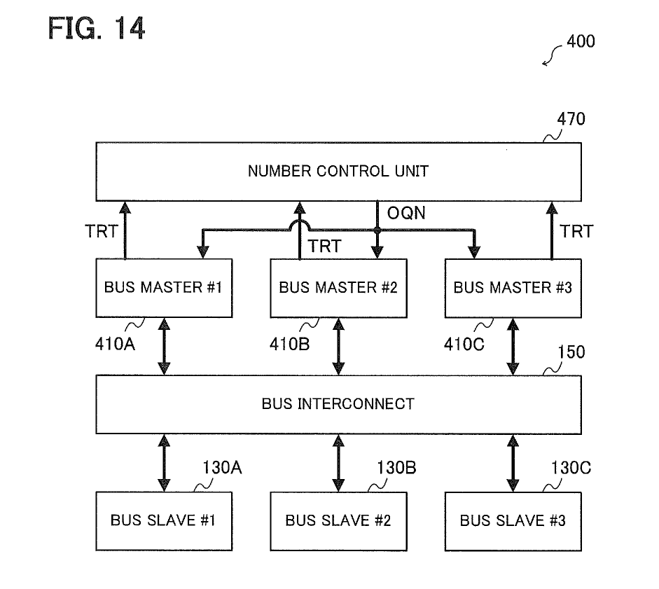

FIG. 14 is a block diagram schematically illustrating the configuration of the bus system 400 according to the fourth embodiment. In this bus system 400, bus masters 410A-410C (referred to as bus masters 410 when it is not particularly necessary to distinguish among them) and bus slaves 130A-130C (referred to as bus slaves 130 when it is not particularly necessary to distinguish among them) are interconnected through a bus interconnect 150. A number control unit 470 is connected to the bus masters 410. The bus system 400 according to the fourth embodiment differs from the bus system 300 according to the third embodiment in regard to the processing in the bus masters 410 and also in having the number control unit 470.

On the basis of the transfer response input times measured by the transfer response input time measurement unit 221 for the bus slaves 130, the number control unit 470 instructs the transfer request output sequence control units 414 to limit the number of output target command information items to a bus slave 130 whose transfer response input time is tending to increase.

For example, the number control unit 470 refers to the transfer response input time signals TRT output from the bus masters 410 and outputs an output number control signal OQN to the bus masters 410. The number control unit 470 monitors the transfer response input times of the bus slaves 130 on the basis of the transfer response input time signals TRT output from the bus masters 410 and supplies the output number control signal OQN to each bus master 410 to decrease the number of transfer requests output to a bus slave 130 whose transfer response input time is increasing.

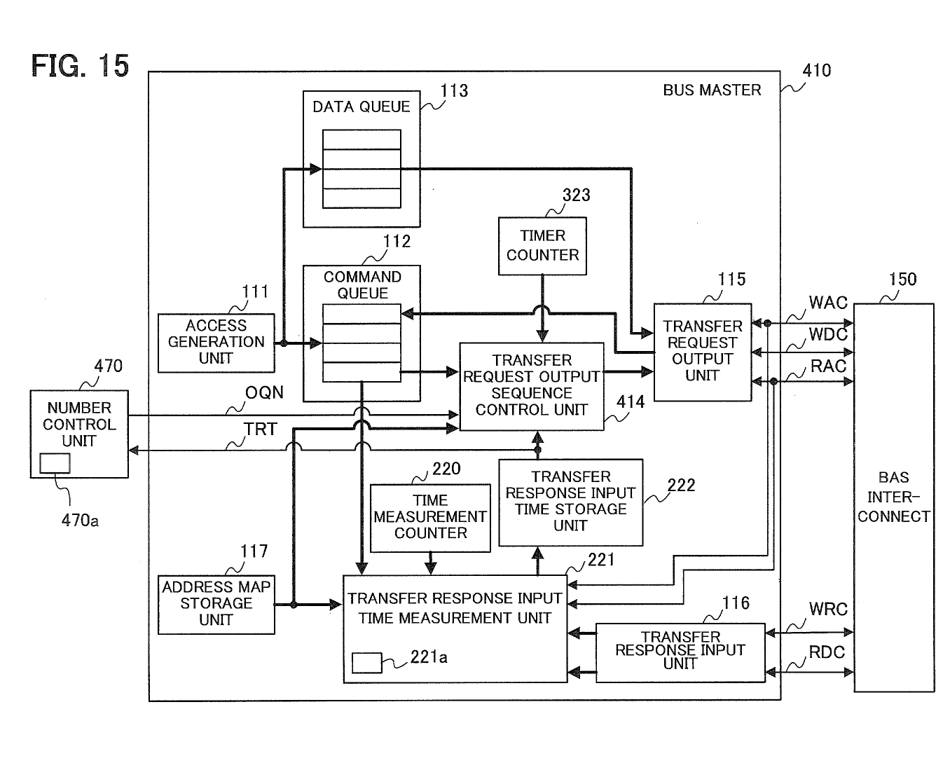

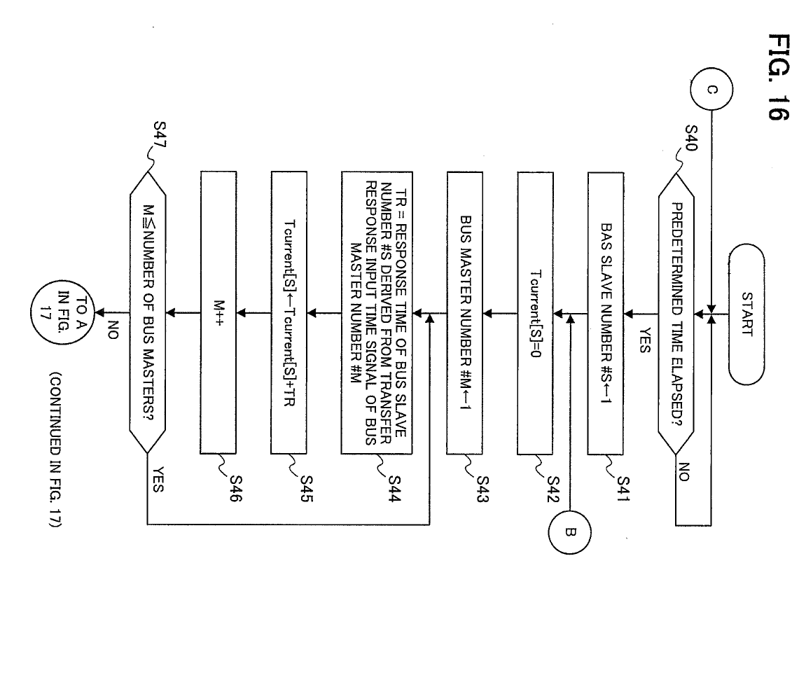

FIG. 15 is a block diagram schematically illustrating the configuration of a bus master 410 in the fourth embodiment. The bus master 410 includes an access generation unit 111, a command queue 112, a data queue 113, a transfer request output sequence control unit 414, a transfer request output unit 115, a transfer response input unit 116, an address map storage unit 117, a time measurement counter 220, a transfer response input time measurement unit 221, a transfer response input time storage unit 222, and a timer counter 323. The bus master 410 in the fourth embodiment differs from the bus master 310 in the third embodiment in the processing in the transfer request output sequence control unit 414. The transfer response input time signal TRT output from the transfer response input time storage unit 222 in the fourth embodiment is supplied to the transfer request output sequence control unit 414 and the number control unit 470.

Like the transfer request output sequence control unit 314 described in the third embodiment, the transfer request output sequence control unit 414 selects a queue item number at which output target command information item is stored on the basis of the transfer response input times FRT of the following slaves, the transfer response input time PRT of the preceding slave, and the count value TT of the timer counter 323, but it also controls the number of output target command information items to the bus slaves 130 in accordance with the output number control signal OQR from the number control unit 470.

For example, if the output number control signal OQR from the number control unit 470 gives an instruction to place an upper limit restriction on the number of transfer requests to a specific bus slave 130, the transfer request output sequence control unit 414 avoids output of a plurality of transfer requests to that specific bus slave 130. If the output number control signal OQR from the number control unit 470 gives an instruction to release the upper limit restriction on the number of transfer requests to the specific bus slave 130, the transfer request output sequence control unit 414 returns to normal operation and can output a plurality of transfer requests to the specific bus slave 130.

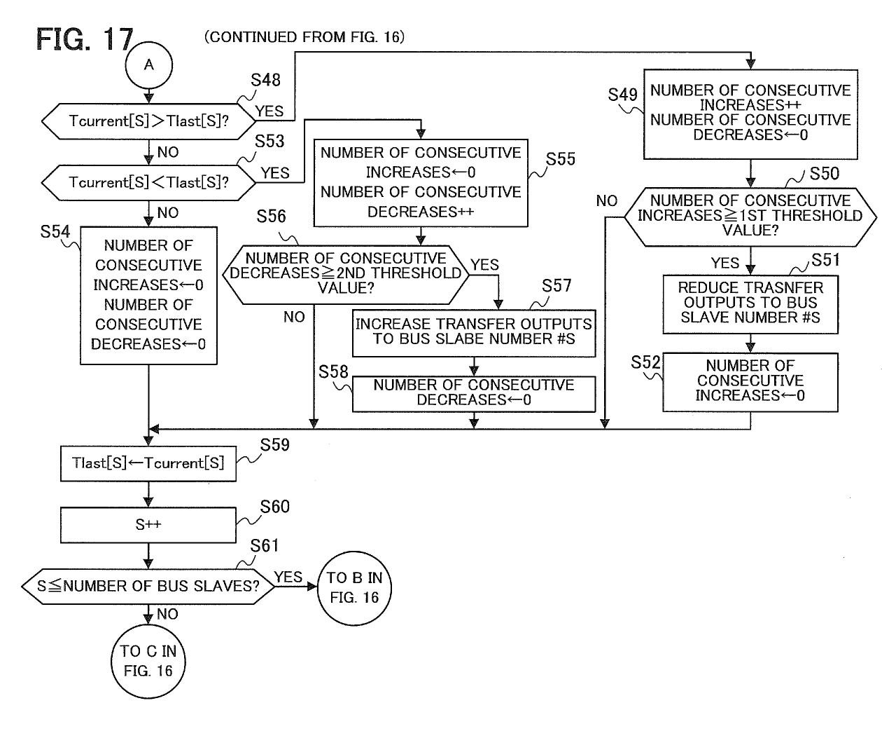

FIGS. 16 and 17 show a flowchart illustrating the process by which the queue control unit 470 obtains transfer response input time signals TRT from the bus masters 410 and supplies the output number control signal OQN to the bus masters 410.

The number control unit 470 refers to the transfer response input time signals TRT at predetermined elapsed time intervals (step S40). In the next step (step S41), the number control unit 470 assigns ‘1’ as the initial value of a bus slave number S. Bus slave number ‘1’ indicates bus slave 130A.

Next, the number control unit 470 sets a value Tcurrent[S], which is the sum of the transfer response input times of the bus slave 130 indicated by bus slave number S, to its initial value of ‘0’ (step S42).

The number control unit 470 next assigns ‘1’ as the initial value of a bus master number M (step S43). Bus master number ‘1’ indicates bus master 110A.

Next, the number control unit 470 obtains the transfer response input time of bus slave number S on the basis of the transfer response input time signal TRT sent from the bus master 410 with bus master number M (step S44). The number control unit 470 sets the obtained response time as a value TR. If the transfer response input times are identified by the transfer type and transfer data length, the number control unit 470 sets the total of all the identified transfer response input times as the TR value.

Next, the number control unit 470 adds the TR value to the Tcurrent[S] value (step S45).

The number control unit 470 next increments the bus master number M by ‘1’ (step S46).

The number control unit 470 checks whether the bus master number M is less than or equal to the number of bus masters 410 connected to the bus interconnect 150 (step S47). If the bus master number M is less than or equal to the number of bus masters 410 (Yes in S47), the process returns to step S44. If bus master number M is greater than the number of bus masters 410 (No in S47), the process proceeds to step S48 in FIG. 17.

By the process in steps S42 to S47, the number control unit 470 can calculate the total value of the transfer response input times of the bus slave 130 with bus slave number S. If there are a plurality of bus masters 410, the total value is obtained by summing the transfer response input times calculated by the plurality of bus masters 410. If the transfer response input times of the respective bus slaves 130 are identified by the transfer type and transfer data length, the transfer response input times of each bus slave 130 are added up, without identifying them by transfer type and transfer data length.

In step S48 in FIG. 17, the number control unit 470 reads from a memory 470a a total value Tlast[S] of the transfer response input times of bus slave number S that was referred to last time. The number control unit 470 checks whether the Tcurrent[S] value is greater than the Tlast[S] value. If the Tcurrent[S] value is greater than the Tlast[S] value (Yes in S48), the process proceeds to step S49; if the Tcurrent[S] value is not greater than the Tlast[S] value (No in S48), the process proceeds to step S53.

In step S49, the number control unit 470 determines that the transfer response time of the bus slave 130 with bus slave number S has increased, increments the number of consecutive increases by ‘1’, and returns the number of consecutive decreases to its initial value of ‘0’.

Next, the number control unit 470 checks whether the number of consecutive increases is greater than or equal to a predetermined first threshold value (step S50). If the number of consecutive increases is greater than or equal to the first threshold value (Yes in S50), the process proceeds to step S51; if the number of consecutive increases is less than the first threshold value (No in S50), the process proceeds to step S59.

In step S51, the number control unit 470 determines that the transfer load on the bus slave 130 with bus slave number S is high. The number control unit 470 then supplies all the bus masters 410 with an output number control signal OQN that gives an instruction to place an upper limit restriction on the number of output transfer requests.

The transfer request output sequence control unit 414 of a bus master 410 which receives this instruction avoids output of a plurality of transfer requests to the bus slave 130 with bus slave number S.

The number control unit 470 next returns the number of consecutive increases to its initial value of ‘0’ (step S52). The process then proceeds to step S59.

If it is determined in step S48 that the Tcurrent[S] value does not exceed the Tlast[S] value (No in S48), the process proceeds to step S53.

In step S53, the number control unit 470 checks whether the Tcurrent[S] value is smaller than the Tlast[S] value. If the Tcurrent[S] value is not smaller than the Tlast[S] value (No in S53), that is, if the Tcurrent[S] value equals the Tlast[S] value, the process proceeds to step S54. If the Tcurrent[S] value is smaller than the Tlast[S] value (Yes in S53), the process proceeds to step S55.

In step S54, the number control unit 470 returns the number of consecutive increases and the number of consecutive decreases to their initial values of ‘0’.

In step S55, the number control unit 470 determines that the transfer response time of the bus slave 130 with bus slave number S has decreased, adds ‘1’ to the number of consecutive decreases, and returns the number of consecutive increases to its initial value of ‘0’.

The number control unit 470 then checks whether the number of consecutive decreases is greater than or equal to a second predetermined threshold value (step S56). If the number of consecutive decreases is greater than or equal to the second threshold value (Yes in S56), the process proceeds to step S57; if the number of consecutive decreases is less than the second threshold value (No in S56), the process proceeds to step S59.

In step S57, the number control unit 470 determines that the transfer load on the bus slave 130 with bus slave number S has decreased. The number control unit 470 supplies all the bus masters 410 with an output number control signal OQN that gives an instruction to release the upper limit restriction on the number of output transfer requests.

The transfer request output sequence control unit 414 of a bus master 410 that has received this instruction outputs transfer requests to the bus slave 130 with bus slave number S without waiting until a transfer response is obtained from this bus slave 130.

Next, the number control unit 470 returns the number of consecutive decreases to its initial value of ‘0’ (step S58). The process then proceeds to step S59.

In step S59, the number control unit 470 updates the Tlast[S] value stored in the memory 470a with the calculated Tcurrent[S] value.

The number control unit 470 then increments bus slave number S by ‘1’ (step S60).

Next, the number control unit 470 checks whether bus slave number S is less than or equal to the number of bus slaves (step S61). If bus slave number S is less than or equal to the number of bus slaves (Yes in S61), the process proceeds to step S42 in FIG. 16. If bus slave number S is greater than the number of bus slaves (No in S61), the process proceeds to step S40 in FIG. 16.

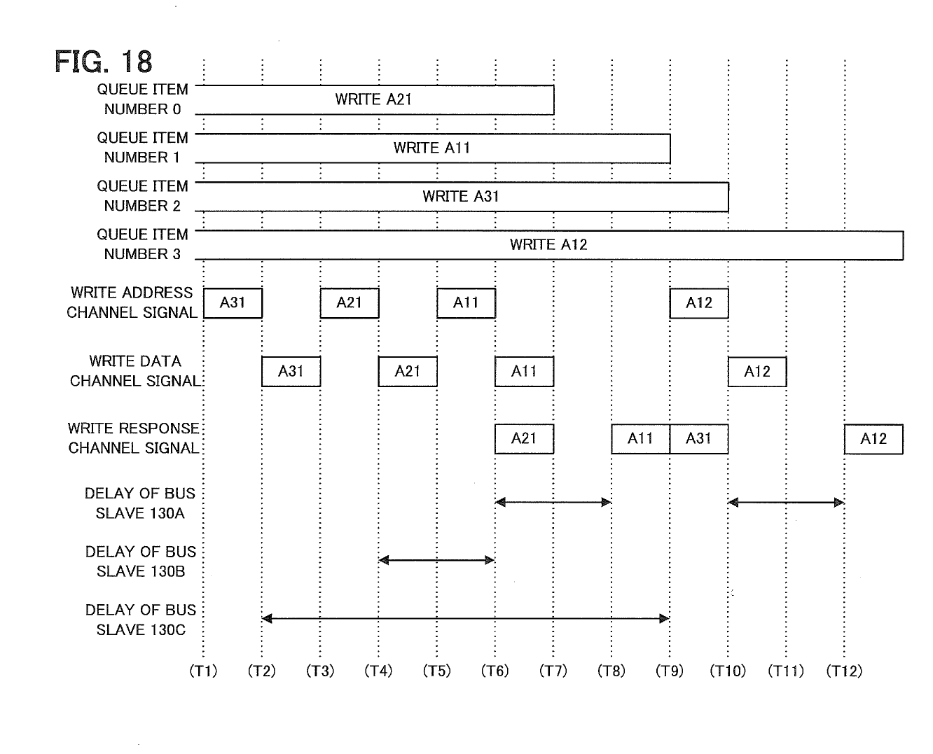

FIG. 18 is a timing diagram illustrating the operation of a bus master 410 when its transfer request output sequence control unit 414 imposes an upper limit restriction on the number of transfer requests output to bus slave 130A.

As shown in FIG. 18, after outputting the write address channel signal WAC to bus slave 130A at time T5, the transfer request output sequence control unit 414 does not output another transfer request to bus slave 130A until the transfer response is obtained at time T8. By executing this type of operation, the transfer request output sequence control unit 414 prevents a plurality of transfer requests from being output to bus slave 130A and reduces the transfer load on bus slave 130A.

As described above, the bus system 400 according to the fourth embodiment restricts the number of transfer requests from a bus master 410 to a bus slave 130 with a temporarily increased transfer load, thereby reducing the transfer load on the bus slave 130, and consequently can shorten the time from when the bus master 410 outputs a transfer request until the transfer response is obtained.

### Fifth Embodiment

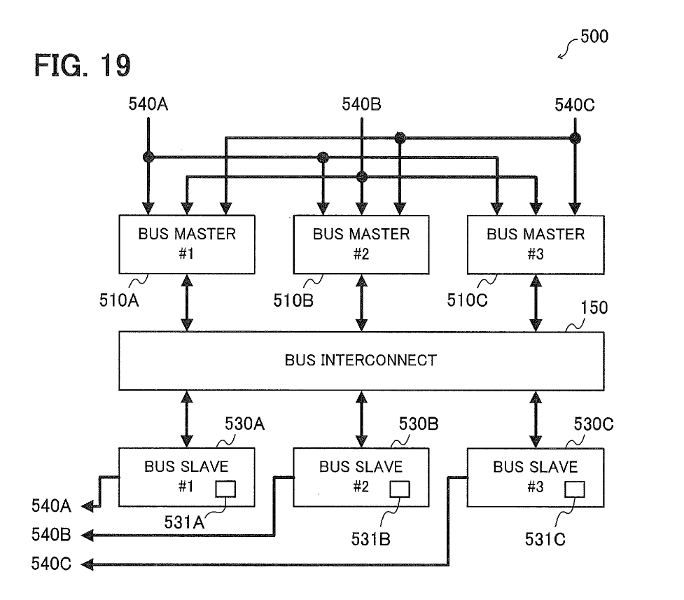

FIG. 19 is a block diagram schematically illustrating the configuration of the bus system 500 according to the fifth embodiment. In this bus system 500, bus masters 510A-510C (referred to as bus masters 510 when it is not particularly necessary to distinguish among them) and bus slaves 530A-530C (referred to as bus slaves 530 when it is not particularly necessary to distinguish among them) are interconnected through a bus interconnect 150. The bus masters 510 are informed of the maximum numbers of transfer requests that can be accepted by the bus slaves 530A-530C (referred to as their maximum transfer request capacities 540A-540C, or as maximum transfer request capacities 540 when it is not particularly necessary to distinguish among them). The bus system 500 in the fifth embodiment differs from the bus system 100 in the first embodiment in the processing in the bus masters 510 and in that the bus slaves 530 report their maximum transfer request capacities 540 to the bus masters 510. The maximum transfer request capacities 540 are the maximum numbers of transfer requests that can accumulate inside the respective bus slaves 530. The maximum transfer request capacities 540 are predetermined in the system and are stored in memories 531A-531C (referred to as memories 531 when it is not particularly necessary to distinguish among them) in the respective bus slaves 530.

The bus slaves 530 receives write address channel signals and write data channel signals or read address channels signal issued from the bus masters 510A-510C through the bus interconnect 150. The bus slaves 530 generate control signals in accordance with the received channel signals. If a bus slave 530 is an SRAM, an SRAM write or read signal is generated, and when the write or read operation is completed, a write response channel signal or a read data channel signal is passed through the bus interconnect 150 to the bus master 510.

If a bus slave 530 is an external serial interface or the like, the write address channel signal and write data channel signal or the read address channel signal is converted to a serial signal and output to an external device, and a serial signal input from the external device is converted to a write response channel signal or read data channel signal and passed to the bus interconnect 150 in the manner described above.

If another write address channel signal or read address channel signal is input to a bus slave 530 in the period from when the bus slave 530 receives a write address channel signal or read address channel signal, that is, a transfer request, from one of the bus masters 510A-510C, until the write response channel signal or read data channel signal is issued, whether the bus slave 530 accepts the signal depends on the configuration of the bus slave 530. For example, if the bus slave 530 has an internal buffer in which transfer requests can accumulate and if space for storing the transfer request is available in the buffer, the bus slave 530 outputs a Ready signal, receives the write address channel signal and write data channel signal or the read address channel signal, and stores the received signal(s) in the buffer inside the bus slave 530.

If the bus slave 530 does not have a buffer as described above or if the buffer does not have sufficient space to store the transfer request, the bus slave 530 does not assert the Read signal, thereby informing the bus interconnect 150 that it is not accepting the transfer request. Having received this notification of withheld acceptance of the request from the bus slave 530, the bus interconnect 150 does not make any new transfer request to the bus slave 530 until the withholding is cancelled, and transfers to the bus slaves 530 in the system are stalled.

When the transfer in progress is completed in the bus slave 530 and the bus slave 530 does not have any transfer request to process, or when space for storing a transfer request becomes available in the buffer, the bus slave 530 asserts the Ready signal and obtains the transfer request that was left unaccepted from the bus interconnect 150.

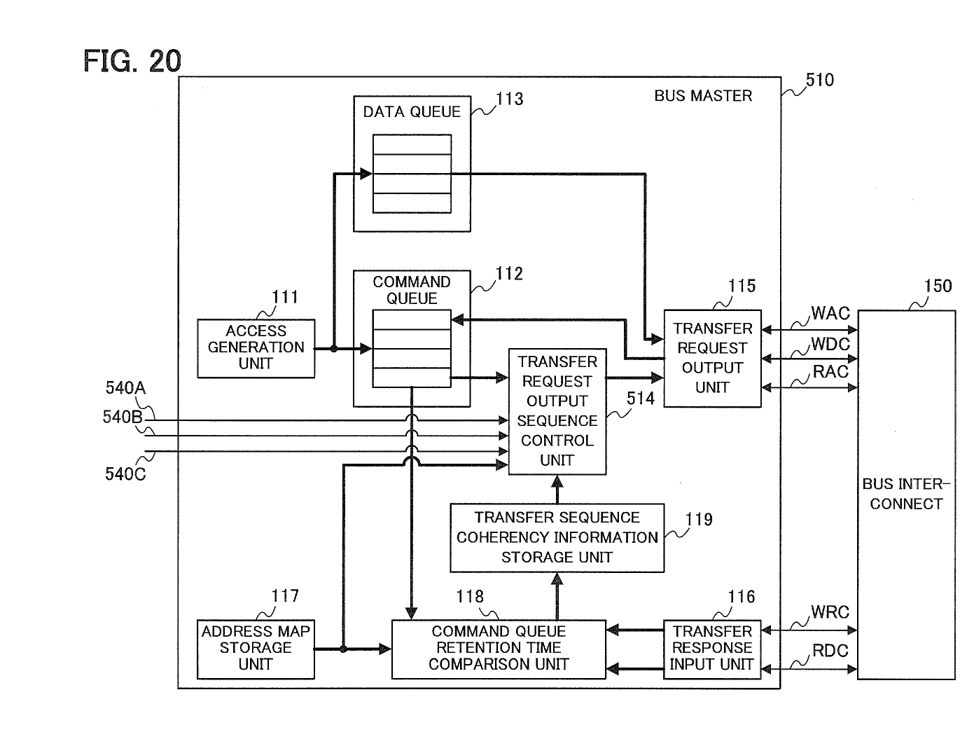

The bus master 510 obtains the maximum transfer request capacities 540 of the bus slaves 530 and selects a command information item stored in the command queue 112. FIG. 20 is a block diagram schematically illustrating the configuration of a bus master 510 in the fifth embodiment. The bus master 510 according to the fifth embodiment differs from the bus master 110 according to the first embodiment in that the maximum transfer request capacities 540A-540C of the bus slaves 530A-530C are input to the transfer request output sequence control unit 514.

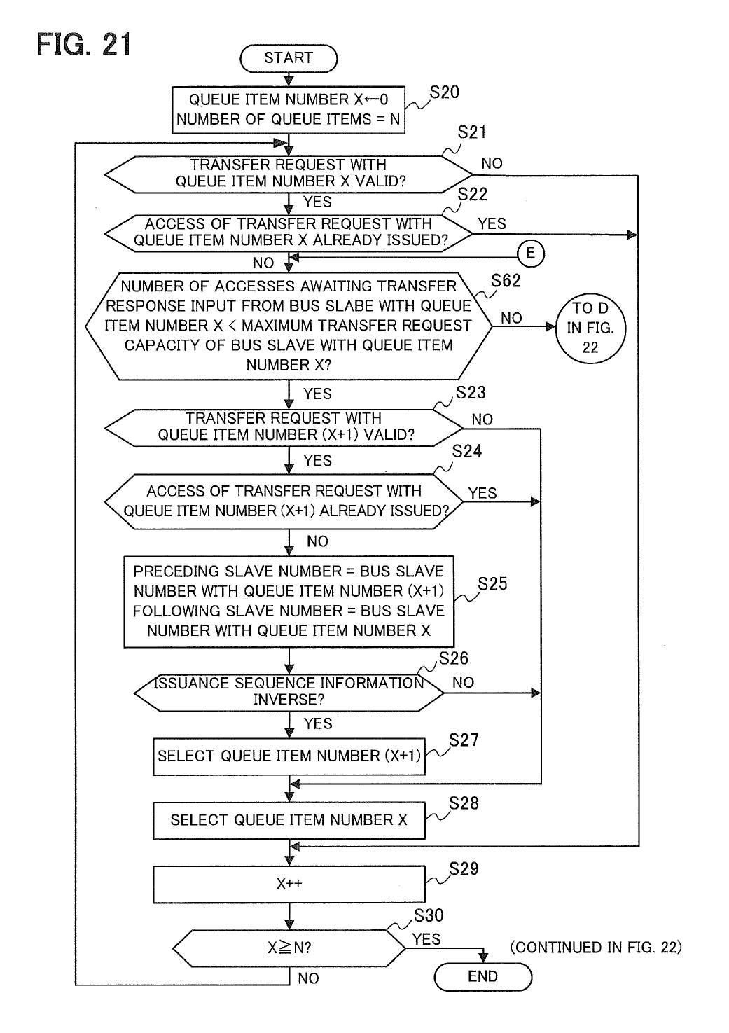

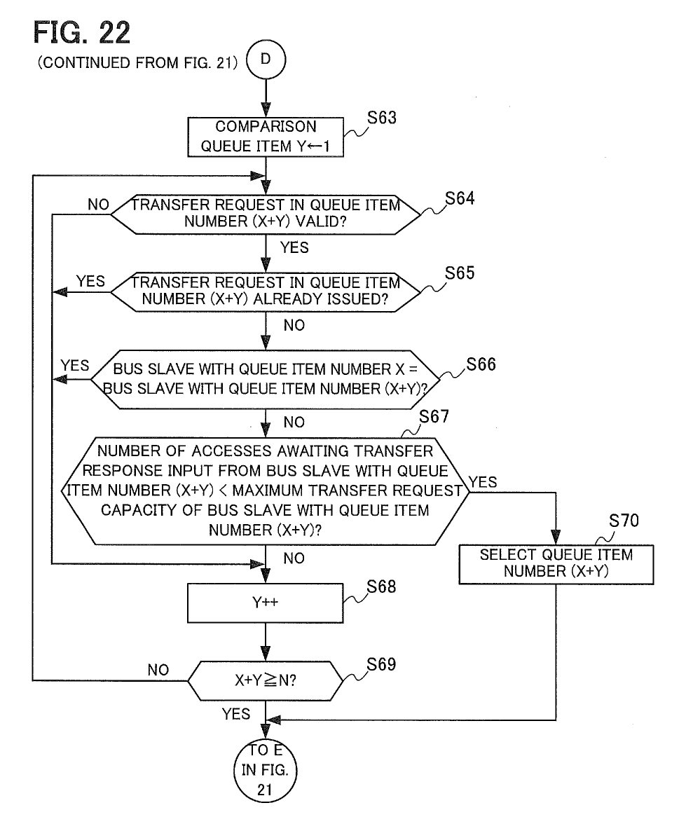

FIGS. 21 and 22 show a flowchart illustrating a process in which the transfer request output sequence control unit 514 in the fifth embodiment selects a command information item with one of the queue item numbers stored in the command queue 112. In the flowchart shown in FIGS. 21 and 22, steps identical to steps shown in FIG. 7 are denoted by the same numerals as used in FIG. 7.

The process in steps S20 to S22 in FIG. 21 is the same as the process in steps S20 to S22 in FIG. 7. In step S22 in FIG. 21, however, if the command information item with queue item number X has not been output (No in S22), the process proceeds to step S62.

In step S62, the transfer request output sequence control unit 514 refers to the command queue 112 and, among transfer requests to the same bus slave 530 as the bus slave 530 possessing the transfer target address with queue item number X, counts the number of transfer requests that are valid in the queue and have already been output, and sets this number as the number of accesses awaiting transfer response input. The transfer request output sequence control unit 514 checks whether the number of accesses awaiting transfer response input falls short of the maximum transfer request capacity 540 of the bus slave 530. If the number of accesses awaiting transfer response input falls short of the maximum transfer request capacity 540 (Yes in S26), the process proceeds to step S23 and, like the transfer request output sequence control unit 114 in the first embodiment, the transfer request output sequence control unit 514 then determines the output sequence in relation to the command information item stored next. If the number has reached the maximum transfer request capacity 540 of the bus slave 530 (No in S26), the process proceeds to step S63 in FIG. 22.

In step S63 in FIG. 22, the transfer request output sequence control unit 514 sets a variable Y, which identifies the queue to be compared, to its initial value (here ‘1’).

The transfer request output sequence control unit 514 then refers to the management information stored in the command queue 112 to decide whether the command information item with queue item number X+Y is ‘valid’ (step S64). If the command information item with queue item number X+Y is ‘valid’ (Yes in S64), the process proceeds to step S65; if the command information item with queue item number X+Y is ‘invalid’ (No in S64), the process proceeds to step S68.

In step S65, the transfer request output sequence control unit 514 refers to the management information stored in the command queue 112 to check whether the command information item with queue item number X+Y has already been output. If the command information item with queue item number X has already been output (Yes in S65), the process proceeds to step S68; if the command information item with queue item number X+Y has not been output (No in S65), the process proceeds to step S66.

In step S66, the transfer request output sequence control unit 514 refers to the command information stored in the command queue 112 and checks whether the transfer destination bus slave 530 with queue item number X matches the transfer destination bus slave 530 with queue item number X+Y. If these bus slaves match (Yes in S66), the process proceeds to step S68; if the bus slaves are different (N in S66), the process proceeds to step S67.

Through the process in steps S63 to S66, the transfer request output sequence control unit 514 can detect transfer requests satisfying the conditions that they are valid in the queue (Yes in S64), their command information has not been output (No in S65), and their transfer destination bus slave 530 differs from the bus slave 530 with queue item number X (No in S66), among the transfer requests enqueued with queue item number X or above, in the order in which they were enqueued.

In step S67, the transfer request output sequence control unit 514 counts the number of already-output transfer requests that are valid in the queue, among transfer requests to a bus slave 530 matching the bus slave 530 possessing the transfer target address with queue item number X+Y. The transfer request output sequence control unit 514 checks whether the counted number falls short of the maximum transfer request capacity 540 of the bus slave 530. If the counted number has reached the maximum transfer request capacity 540 of the bus slave 530 (No in S67), the process proceeds to step S68; if the counted number has not reached the maximum transfer request capacity 540 of the bus slave 530 (Yes in S67), the process proceeds to step S70.

In step S68, the transfer request output sequence control unit 514 increments variable Y by ‘1’.

The transfer request output sequence control unit 514 checks whether queue item number X+Y is greater than or equal to the number of queue items N (step S69). If queue item number X+Y is greater than or equal to the number of queue items N (Yes in S69), the process returns to step S62 in FIG. 21; if queue item number X+Y is not greater than or equal to queue length N (No in S69), the process returns to step S64.

In step S70, the transfer request output sequence control unit 514 supplies the command information item with queue item number X+Y to the transfer request output unit 115 and has it output the command information item. In other words, the command information item with queue item number X+Y is output earlier than the command information item with queue item number X.

In the fifth embodiment, as described above, a command information item is not output to a bus slave 530 whose maximum transfer request capacity has been reached, and if a command information item stored later is directed to a bus slave 530 whose maximum transfer request capacity has not been reached, the command information item directed to that bus slave 530 is output earlier. Therefore, bus transfers can be performed without exceeding the data transfer capacities of the bus slaves 530 and the bus slaves 530 can avoid the state of leaving transfer requests unaccepted. Besides, bus transfers suited to the data transfer load states of the bus slaves 530 can be performed.

The bus master 510 according to the fifth embodiment has been described on the basis of the bus master 110 according to the first embodiment, but the maximum transfer request capacities 540A-540C may be applied to the transfer request output sequence control units 214, 314, 414 of the bus masters 210, 310, 410 according to the other embodiments. In that configuration, since the bus masters 210, 310, 410 do not select command information items whose transfer request will be left unaccepted by the bus slaves 530, bus transfers can be performed without exceeding the data transfer capacity of the bus slaves 530.

The bus system 500 according to the fifth embodiment is configured to report the maximum transfer request capacities 540 of the bus slaves 530 to the bus masters 510, but this configuration is exemplary and not limiting. For example, instead of reporting the maximum transfer request capacity 540, the transfer request acceptance state of the bus slaves 530 may be monitored, the number of currently accumulated requests may be subtracted from the maximum transfer request capacity, and the difference may be reported to the bus masters 510 as the maximum transfer request capacity. By referring to the varying maximum transfer request capacities of the bus slaves 530, bus transfers can be performed in a manner even better suited to the data transfer load states of the bus slaves 530.

### EXPLANATION OF REFERENCE CHARACTERS

100, 200, 300, 400, 500 bus system, 110, 210, 310, 410, 510 bus master, 111 access generation unit, 112 command queue, 113 data queue, 114, 214, 314, 414, 514 transfer request output sequence control unit, 115 transfer request output unit, 116 transfer response input unit, 117 address map storage unit, 118 command queue retention time comparison unit, 119 transfer sequence coherency information storage unit, 220 time measurement counter, 221 transfer response input time measurement unit, 222 transfer response input time storage unit, 323 timer counter, 130, 530 bus slave, 150 bus interconnect, 470 number control unit.

1. A bus master comprising:
an access generation unit that generates a command information item including a transfer type indicating a type of transfer request that requests a transfer of data and a transfer target address of a bus slave to which the transfer request is directed;
a command queue that stores a plurality of the command information items generated by the access generation unit;
a transfer request output sequence control unit that selects a second command information item before a first command information item as a output target command information item from the plurality of command information items stored in the command queue, the second command information item including a transfer target address possessed by a second bus slave that responds more slowly than a first bus slave possessing the transfer target address included in the first command information item; and
a transfer request output unit that outputs the command information item selected by the transfer request output sequence control unit to the bus slave possessing the transfer target address included in the selected command information item.

2. The bus master of claim 1, further comprising:
a transfer response input unit that receives input of a response, to the command information item output from the transfer request output unit, from the bus slave possessing the transfer target address included in the command information item;
a command queue retention time comparison unit that, when the response to the command information item output from the transfer request output unit is input to the transfer response input unit before a response to a command information item output earlier than that command information item, identifies the bus slave possessing the transfer target address included in the command information item output earlier as a preceding slave, identifies the bus slave possessing the transfer target address included in the command information item output later as a following slave, and determines that the responses from the preceding slave and the following slave are reversed; and
a transfer sequence coherency information storage unit that stores transfer sequence coherency information including information indicating that the responses from the preceding slave and the following slave are reversed, in accordance with a result of the determination by the command queue retention time comparison unit; wherein
in selecting the output target command information item, the transfer request output sequence control unit refers to the transfer sequence coherency information stored in the transfer sequence coherency information storage unit.

3. The bus master of claim 2, wherein the transfer request output sequence control unit treats a bus slave possessing a transfer target address included in command information item stored first among the command information items stored in the command queue as the preceding slave, treats a bus slave possessing a transfer target address included in the command information item stored next as the following slave, and when information indicating that the responses are reversed is included in the transfer sequence coherency information, selects the command information item stored next as the output target command information item before selecting the command information item stored first.

4. The bus master of claim 2 wherein, when among the command information items output to a single bus slave possessing the transfer target address included in the command information item stored first among the command information items stored in the command queue, the number of command information items to which no response has yet been received reaches a maximum number of command information items that the single bus slave can accumulate, the transfer request output sequence control unit selects a command information item including a transfer target address of another bus slave that has not reached its maximum accumulatable number of command information items as output target command information item before selecting the command information item stored first.

5. The bus master of claim 1, further comprising:
a transfer response input unit that receives input of a response, to the command information item output from the transfer request output unit, from the bus slave possessing the transfer target address included in the command information item;
a transfer response input time measurement unit that measures a transfer response input time from output of the command information item from the transfer request output unit until the transfer response input unit receives input of the response; and
a transfer response input time storage unit that stores the transfer response input times measured by the transfer response input time measurement unit for respective bus slaves; wherein
the transfer request output sequence control unit selects the output target command information item on a basis of the transfer response input times stored in the transfer response input time storage unit.

6. The bus master of claim 5, wherein the transfer request output sequence control unit refers to the transfer response input times stored in the transfer response input time storage unit, and when, among the command information items stored in the command queue, the transfer response input time of a bus slave possessing a transfer target address included in the command information item stored first is shorter than the transfer response input time of a bus slave possessing a transfer target address included in command information item stored next, the transfer request output sequence control unit selects the command information item stored next as the output target command information item before selecting the command information item stored first.

7. The bus master of claim 5, wherein the transfer request output sequence control unit refers to the transfer response input times stored in the transfer response input time storage unit, and when, among the command information items stored in the command queue, excluding the command information items stored first, the transfer response input time of a bus slave possessing a transfer target address included in some single command information item is longer than a time obtained by adding an elapsed time from a predetermined time to the transfer response input time of the bus slave possessing the transfer target address included in the command information item stored first, the transfer request output sequence control unit selects the some single command information item as the output target command information item before selecting the command information item stored first.

8. The bus master of claim 5, wherein:
the transfer request output sequence control unit limits the number of outputs of the command information item to a bus slave indicated by a number control unit; and
on a basis of the transfer response input times measured by the transfer response input time measurement unit for respective bus slaves, the number control unit instructs the transfer request output sequence control unit to limit the number of outputs of the command information item to a bus slave whose transfer response input time is tending to increase.

9. A bus system having at least one bus master and a plurality of bus slaves, wherein
the at least one bus master comprises:
an access generation unit that generates a command information item including a transfer type indicating a type of transfer request that requests a transfer of data and a transfer target address of one bus slave, to which the transfer request is directed, among the plurality of bus slaves;
a command queue that stores a plurality of the command information item generated by the access generation unit;
a transfer request output sequence control unit that selects second command information item before first command information item as output target command information item from the plurality of command information items stored in the command queue, the second command information item including a transfer target address possessed by a second bus slave that responds more slowly than a first bus slave possessing the transfer target address included in the first command information item; and
a transfer request output unit that outputs the command information item selected by the transfer request output sequence control unit to the bus slave possessing the transfer target address included in the selected command information item.

10. The bus system of claim 9, wherein the bus master further comprises:
a transfer response input unit that receives input of a response, to the command information item output from the transfer request output unit, from the bus slave possessing the transfer target address included in the command information item;
a command queue retention time comparison unit that, when the response to the command information item output from the transfer request output unit is input to the transfer response input unit before a response to a command information item output earlier than that command information item, identifies the bus slave possessing the transfer target address included in the command information item output earlier as a preceding slave, identifies the bus slave possessing the transfer target address included in the command information item output later as a following slave, and determines that the responses from the preceding slave and the following slave are reversed; and
a transfer sequence coherency information storage unit that stores transfer sequence coherency information including information indicating that the responses from the preceding slave and the following slave are reversed, in accordance with a result of the determination by the command queue retention time comparison unit; wherein
in selecting the output target command information item, the transfer request output sequence control unit refers to the transfer sequence coherency information stored in the transfer sequence coherency information storage unit.

11. The bus system of claim 10, wherein the transfer request output sequence control unit treats a bus slave possessing a transfer target address included in a command information item stored first among the command information items stored in the command queue as the preceding slave, treats a bus slave possessing a transfer target address included in a command information item stored next as the following slave, and when information indicating that the responses are reversed is included in the transfer sequence coherency information, selects the command information item stored next as the output target command information item before selecting the command information item stored first.

12. The bus system of claim 10 wherein, when among the command information items output to a single bus slave possessing the transfer target address included in the command information item stored first among the command information item stored in the command queue, the number of a command information item to which no response has yet been received reaches a maximum number of a command information item that the single bus slave can accumulate, the transfer request output sequence control unit selects an item of including a transfer target address of another bus slave that has not reached its maximum accumulatable number of a command information item as output target command information item before selecting the command information item stored first.

13. The bus system of claim 9, further comprising:
a transfer response input unit that receives input of a response, to a command information item output from the transfer request output unit, from the bus slave possessing the transfer target address included in the command information item;
a transfer response input time measurement unit that measures a transfer response input time from output of the command information item from the transfer request output unit until the transfer response input unit receives input of the response; and
a transfer response input time storage unit that stores the transfer response input times measured by the transfer response input time measurement unit for respective bus slaves; wherein
the transfer request output sequence control unit selects the output target command information item on a basis of the transfer response input times stored in the transfer response input time storage unit.

14. The bus system of claim 13, wherein the transfer request output sequence control unit refers to the transfer response input times stored in the transfer response input time storage unit, and when, among the command information item stored in the command queue, the transfer response input time of a bus slave possessing a transfer target address included in command information item stored first is shorter than the transfer response input time of a bus slave possessing a transfer target address included in a command information item stored next, the transfer request output sequence control unit selects the command information item stored next as the output target command information item before selecting the command information item stored first.

15. The bus system of claim 13, wherein the transfer request output sequence control unit refers to the transfer response input times stored in the transfer response input time storage unit, and when, among the command information item stored in the command queue, excluding the command information item stored first, the transfer response input time of a bus slave possessing a transfer target address included in some single command information item is longer than a time obtained by adding an elapsed time from a predetermined time to the transfer response input time of the bus slave possessing the transfer target address included in the command information item stored first, the transfer request output sequence control unit selects the some single command information item as the output target command information item before selecting the command information item stored first.

16. The bus system of claim 13, further comprising a number control unit that instructs the transfer request output sequence control unit to limit the number of outputs of the command information item to a bus slave whose transfer response input time is tending to increase, on a basis of the transfer response input times measured by the transfer response input time measurement unit for respective bus slaves, wherein:
the transfer request output sequence control unit limits the number of outputs of the command information item to the bus slave designated by the number control unit.

17. A bus control method comprising:
an access generation step that generates a command information item including a transfer type indicating a type of transfer request that requests a transfer of data and a transfer target address of a bus slave to which the transfer request is directed;
a command queuing step that stores a plurality of the command information items generated in the access generation step;
a transfer request output sequence control step that selects second command information item before first command information item as output target command information item from the plurality of command information items stored in the command queuing step, the second command information item including a transfer target address possessed by a second bus slave that responds more slowly than a first bus slave possessing the transfer target address included in the first command information item; and
a transfer request output step that outputs the command information item selected in the transfer request output sequence control step to the bus slave possessing the transfer target address included in the selected command information item.
